(19) United States
(12) Patent Application Publication
(10) Pub. No.: US 2026/0175502 A1
(43) Pub. Date: Jun. 25, 2026

(54) CONTROL DEVICE FOR INJECTION MOLDING MACHINE, MANAGEMENT DEVICE FOR INJECTION MOLDING MACHINE, DISPLAY DEVICE, INJECTION MOLDING MACHINE, AND MACHINE LEARNING DEVICE

(71) Applicant: SUMITOMO HEAVY INDUSTRIES, LTD., Tokyo (JP)

(72) Inventor: Takuya MIZUNASHI, Chiba (JP)

(21) Appl. No.: 19/416,459

(22) Filed: Dec. 11, 2025

(30) Foreign Application Priority Data
Dec. 19, 2024 (JP) 2024-224012

(51) Int. Cl. B29C 45/76

(52) U.S. Cl. CPC B29C 45/768; B29C 2945/76949

(57) ABSTRACT

A control device for an injection molding machine includes a controller configured to: acquire first time-series data indicating in time series a result detected by a detection device provided in the injection molding machine for each shot in which a molded article is molded by the injection molding machine; receive, from a trained model, inferred output data as time-series data of the result detected by the detection device in a time zone corresponding to the first time-series data, in a case where the first time-series data is input to the trained model in which machine learning is performed for inferring a time series of the result detected by the detection device for each shot in the injection molding machine; and perform control for detecting an abnormality based on a difference between the first time-series data and the output data.

### CROSS-REFERENCE TO RELATED APPLICATIONS

This application claims priority to Japanese Patent Application No. 2024-224012, filed Dec. 19, 2024, the entire content of which is incorporated herein by reference.

### BACKGROUND

### 1. Technical Field

The present disclosure relates to a control device for an injection molding machine, a management device for an injection molding machine, a display device, an injection molding machine, and a machine learning device.

### 2. Description of Related Art

Conventional injection molding machines are provided with a monitoring function for performing monitoring based on a detection result acquired from a sensor built in or connected to the injection molding machine. The monitoring function includes, for example, a technique in which users set a threshold value for a statistical value based on the detection result or a representative value of the detection result, and determine whether the statistical value or the representative value exceeds the threshold value. The difficulty in intuitively grasping the statistical value or representative value using the technology makes it challenging for users to determine an appropriate threshold based on a molding situation.

In recent years, a technology using a neural network has been proposed for monitoring injection molding machines. For example, related art proposes a technology for generating an estimation model by acquiring a plurality of time-series data sets based on detection signals of a plurality of sensors, processing the time-series data into training data, and then performing training by deep learning with the training data.

### SUMMARY

A control device for an injection molding machine according to one aspect of the present disclosure includes a controller configured to: acquire first time-series data indicating in time series a result detected by a detection device provided in the injection molding machine for each shot in which a molded article is molded by the injection molding machine; receive, from a trained model, inferred output data as time-series data of the result detected by the detection device in a time zone corresponding to the first time-series data, in a case where the first time-series data is input to the trained model in which machine learning is performed for inferring a time series of the result detected by the detection device for each shot in the injection molding machine; and perform control for detecting an abnormality based on a difference between the first time-series data and the output data.

### BRIEF DESCRIPTION OF THE DRAWINGS

FIG. 1 is a diagram illustrating a state of an injection molding machine according to an embodiment at the time of completion of mold opening;

FIG. 2 is a diagram illustrating a state of an injection molding machine according to the embodiment at the time of mold clamping;

FIG. 3 is a conceptual diagram illustrating cooperation between a machine learning device and a control device for an injection molding machine according to a first embodiment through use of a trained model;

FIG. 4 is a diagram illustrating an example of a functional configuration of the machine learning device according to the first embodiment;

FIG. 5 is a diagram illustrating an example of waveform data of actual pressure values as a result detected by a load detector provided in a test injection molding machine or the injection molding machine according to the first embodiment;

FIG. 6 is a diagram illustrating actual pressure values, in a table form, as a result detected by a load detector provided in a test injection molding machine or the injection molding machine according to the first embodiment;

FIG. 7 is a diagram explaining a concept of machine training by a learning part of the machine learning device according to the first embodiment;

FIG. 8 is a diagram illustrating an example of a functional configuration of a control device for the injection molding machine according to the first embodiment;

FIG. 9 is a diagram explaining a concept of processing performed by an abnormality detector and a display controller according to the first embodiment;

FIG. 10 is an explanatory diagram illustrating a residual calculated by the abnormality detector according to the first embodiment;

FIG. 11 is a graph illustrating an actual pressure value, an inferred pressure value, and a residual at a shot number “1004” by the injection molding machine according to the first embodiment;

FIG. 12 illustrates an example of a screen displayed on a display device by a display controller according to the first embodiment;

FIG. 13 illustrates a log information screen that is output by the display controller according to the first embodiment;

FIG. 14 illustrates another aspect of a log information screen that is output by the display controller according to the first embodiment; and

FIG. 15 illustrates configurations of a machine learning device, a group management device, and an injection molding machine according to the second embodiment.

### DETAILED DESCRIPTION

In the technique described in the related art, assigning labels of “good” and “bad” to the training data enables the generated inference model to perform inference. In the technique described in the related art, the need to train the model using various time-series datasets containing molding defects creates a significant work burden.

One aspect of the present disclosure provides a technique that enables easy detection of abnormalities by using a machine learning model.

According to one aspect of the present invention, abnormalities can be easily detected.

Hereinafter, embodiments of the present invention will be described with reference to the drawings. The embodiments described hereinafter are not intended to limit the invention but are merely examples, and all features and combinations thereof described in the embodiments are not necessarily essential to the invention. In the drawings, the same or corresponding components are denoted by the same or corresponding reference numerals, and the description thereof may be omitted.

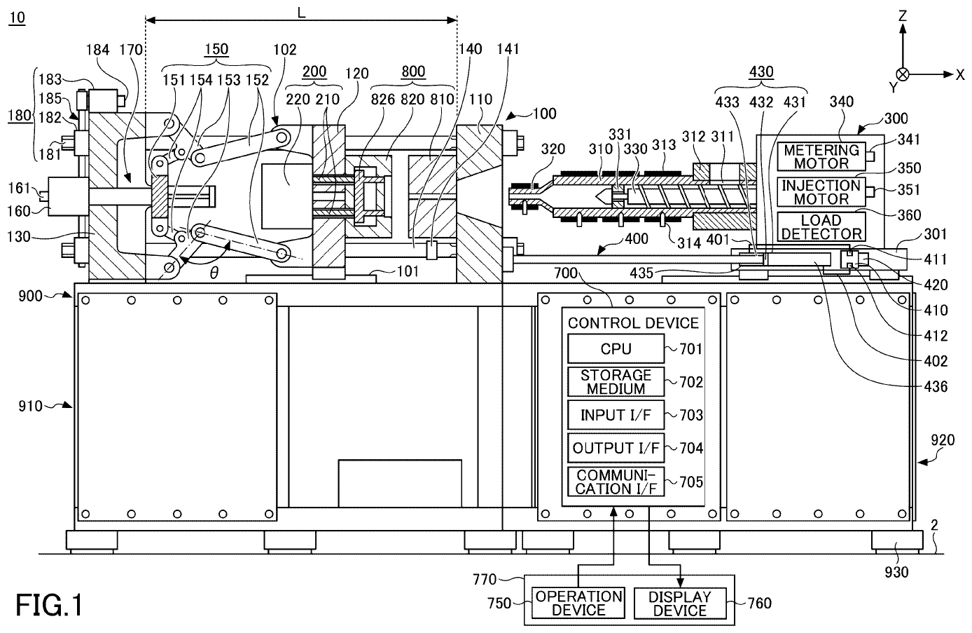

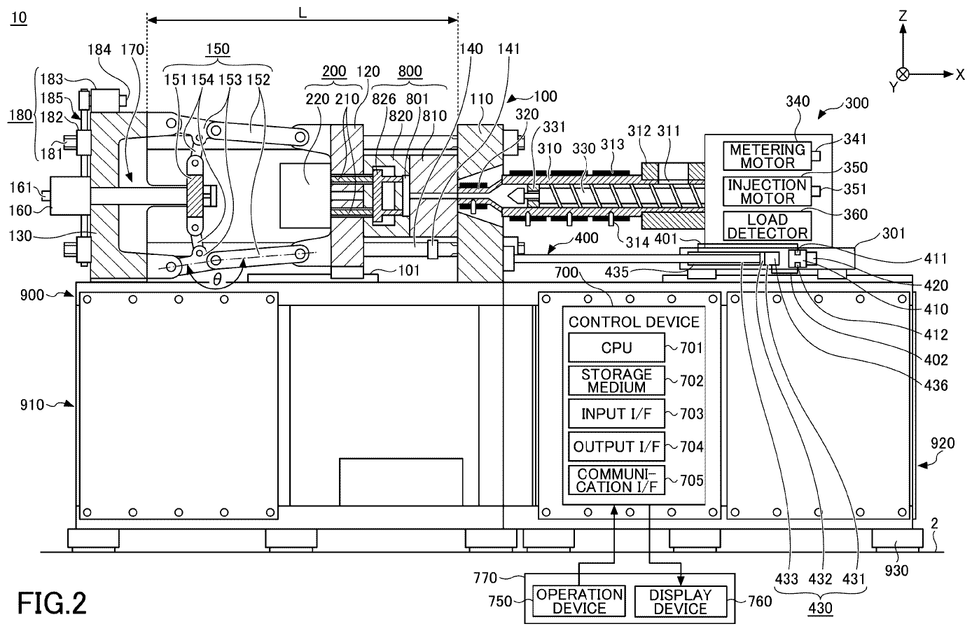

FIG. 1 is a diagram illustrating a state of an injection molding machine according to a first embodiment at the time of completion of mold opening. FIG. 2 is a diagram illustrating a state of an injection molding machine according to the first embodiment at the time of mold clamping. In the present specification, an X-axis direction, a Y-axis direction, and a Z-axis direction are directions perpendicular to each other. The X-axis direction and the Y-axis direction represent a horizontal direction, and the Z-axis direction represents a vertical direction. In the case where a mold clamping device 100 is a horizontal type, the X-axis direction is a mold opening/closing direction, and the Y-axis direction is a width direction of an injection molding machine 10. The negative side in the Y-axis direction is hereinafter called an “operation side”, and the positive side in the Y-axis direction is hereinafter called a “side opposite to the operation side”.

As illustrated in FIGS. 1 and 2, the injection molding machine 10 includes: a mold clamping device 100 that opens and closes the mold device 800; an ejector device 200 that ejects a molded article that is molded by the mold device 800; an injection device 300 that injects a molding material into the mold device 800; a moving device 400 that advances and retracts the injection device 300 with respect to the mold device 800; a control device 700 that controls each component of the injection molding machine 10; and a frame 900 that supports each component of the injection molding machine 10. The frame 900 includes a mold clamping device frame 910 that supports the mold clamping device 100 and an injection device frame 920 that supports the injection device 300. The mold clamping device frame 910 and the injection device frame 920 are installed on the floor 2 via leveling adjusters 930. The control device 700 is provided in the internal space of the injection device frame 920. Hereinafter, each component of the injection molding machine 10 will be described.

### (Mold Clamping Device)

In the description of the mold clamping device 100, a moving direction of a movable platen 120 at the time of mold closing (for example, an X-axis positive direction) is defined as the front, and a moving direction of the movable platen 120 at the time of mold opening (for example, an X-axis negative direction) is defined as the rear.

The mold clamping device 100 performs mold closing, pressure increasing, mold clamping, pressure releasing, and mold opening of the mold device 800. The mold device 800 includes a stationary mold 810 and a movable mold 820.

The mold clamping device 100 is, for example, a horizontal type, and the mold opening/closing direction is a horizontal direction. The mold clamping device 100 includes a stationary platen 110 to which the stationary mold 810 is attached, a movable platen 120 to which the movable mold 820 is attached, and a moving mechanism 102 that moves the movable platen 120 in the mold opening/closing direction with respect to the stationary platen 110.

The stationary platen 110 is fixed to the mold clamping device frame 910. A stationary mold 810 is attached to a surface of the stationary platen 110 facing the movable platen 120.

The movable platen 120 is disposed so as to be movable in the mold opening/closing direction with respect to the mold clamping device frame 910. A guide 101 for guiding the movable platen 120 is laid on the mold clamping device frame 910. The movable mold 820 is attached to a surface of the movable platen 120 facing the stationary platen 110.

The moving mechanism 102 moves the movable platen 120 frontward and rearward with respect to the stationary platen 110 to perform mold closing, pressure increasing, mold clamping, pressure releasing, and mold opening of the mold device 800. The moving mechanism 102 includes: a toggle support 130 disposed at a distance from the stationary platen 110; tie bars 140 each connecting the stationary platen 110 and the toggle support 130; a toggle mechanism 150 configured to move the movable platen 120 in the mold opening/closing direction with respect to the toggle support 130; a mold clamping motor 160 operating the toggle mechanism 150; a motion conversion mechanism 170 converting the rotational motion of the mold clamping motor 160 into linear motion; and a mold thickness adjustment mechanism 180 configured to adjust the distance between the stationary platen 110 and the toggle support 130.

The toggle support 130 is disposed apart from the stationary platen 110 and is placed on the mold clamping device frame 910 so as to be movable in the mold opening/closing direction. The toggle support 130 may be disposed so as to be movable along a guide laid on the mold clamping device frame 910. The guide of the toggle support 130 may be shared with the guide 101 of the movable platen 120.

In the present embodiment, although the stationary platen 110 is fixed to the mold clamping device frame 910, and the toggle support 130 is disposed so as to be movable in the mold opening/closing direction with respect to the mold clamping device frame 910, the toggle support 130 may be fixed to the mold clamping device frame 910, and the stationary platen 110 may be disposed so as to be movable in the mold opening/closing direction with respect to the mold clamping device frame 910.

The tie bar 140 connects the stationary platen 110 and the toggle support 130 with an interval L therebetween in the mold opening/closing direction. A plurality of (for example, four) tie bars 140 may be used. The plurality of tie bars 140 are arranged in parallel in the mold opening/closing direction and extend in accordance with a mold clamping force. At least one of the tie bars 140 is provided with a tie bar strain detector 141 for detecting strain of the tie bar 140. The tie bar strain detector 141 sends a signal indicating a result of the detection to the control device 700. The detection result of the tie bar strain detector 141 is used for detection of a mold clamping force and the like.

In the present embodiment, the tie bar strain detector 141 is used as a mold clamping force detector for detecting a mold clamping force, but the present invention is not limited thereto. The mold clamping force detector is not limited to a strain gauge type, and may be a piezoelectric type, a capacitance type, a hydraulic type, an electromagnetic type, or the like, and the attachment position thereof is not limited to the tie bar 140.

The toggle mechanism 150 is disposed between the movable platen 120 and the toggle support 130, and moves the movable platen 120 in the mold opening/closing direction with respect to the toggle support 130. The toggle mechanism 150 includes a crosshead 151 that moves in the mold opening/closing direction, and a pair of link groups that are bent and extended by the movement of the crosshead 151. The pair of link groups each include a first link 152 and a second link 153 which are connected to each other by a pin or the like so as to be bendable and extendable. The first link 152 is swingably attached to the movable platen 120 by a pin or the like. The second link 153 is swingably attached to the toggle support 130 by a pin or the like. The second link 153 is attached to the crosshead 151 via a third link 154. In response to the crosshead 151 moving frontward and rearward with respect to the toggle support 130, the first link 152 and the second link 153 are bent and extended, and the movable platen 120 is moved frontward and rearward with respect to the toggle support 130.

The configuration of the toggle mechanism 150 is not limited to the configuration illustrated in FIGS. 1 and 2. For example, in FIGS. 1 and 2, the number of nodes of each link group is five, but may be four, and one end of the third link 154 may be coupled to the node between the first link 152 and the second link 153.

The mold clamping motor 160 is attached to the toggle support 130 and operates the toggle mechanism 150. By moving the crosshead 151 frontward and rearward with respect to the toggle support 130, the mold clamping motor 160 bends and extends the first link 152 and the second link 153 and moves the movable platen 120 frontward and rearward with respect to the toggle support 130. The mold clamping motor 160 is directly connected to the motion conversion mechanism 170, but may be connected to the motion conversion mechanism 170 via a belt, a pulley, or the like.

The motion conversion mechanism 170 converts a rotational motion of the mold clamping motor 160 into the linear motion of the crosshead 151. The motion conversion mechanism 170 includes a screw shaft and a screw nut screwed to the screw shaft. Balls or rollers may be interposed between the screw shaft and the screw nut.

The mold clamping device 100 performs a mold closing step, a pressure increasing step, a mold clamping step, a pressure releasing step, a mold opening step, and the like under the control of the control device 700.

In the mold closing step, the mold clamping motor 160 is driven to advance the crosshead 151 to a mold closing completion position at a set moving speed, thereby advancing the movable platen 120 and causing the movable mold 820 to touch the stationary mold 810. The position and the moving speed of the crosshead 151 are detected by using, for example, a mold clamping motor encoder 161. The mold clamping motor encoder 161 detects the rotation of the mold clamping motor 160 and sends a signal indicating the detection result to the control device 700.

A crosshead position detector that detects the position of the crosshead 151 and a crosshead moving speed detector that detects the moving speed of the crosshead 151 are not limited to the mold clamping motor encoder 161, and general detectors can be used. The movable platen position detector for detecting the position of the movable platen 120 and the movable platen moving speed detector for detecting the moving speed of the movable platen 120 are not limited to the mold clamping motor encoder 161, and general detectors can be used.

In the pressure increasing step, a mold clamping force is generated by further driving the mold clamping motor 160 to further advance the crosshead 151 from the mold closing completion position to a mold clamping position.

In the mold clamping step, the mold clamping motor 160 is driven to maintain the position of the crosshead 151 at the mold clamping position. In the mold clamping step, the mold clamping force generated in the pressure increasing step is maintained. In the mold clamping step, a cavity space 801 (see FIG. 2) is formed between the movable mold 820 and the stationary mold 810, and the injection device 300 fills the cavity space 801 with a liquid molding material. The filled molding material is solidified to obtain a molded article.

There may be more than one cavity space 801. In this case, a plurality of molded articles are obtained simultaneously. An insert component may be disposed in one part of the cavity space 801, and a molding material may be filled in another part of the cavity space 801. A molded article in which the insert component and the molding material are integrated is obtained.

In the pressure releasing step, the movable platen 120 is retracted by driving the mold clamping motor 160 to retract the crosshead 151 from the mold clamping position to the mold opening start position, and the mold clamping force is thus reduced. The mold opening start position and the mold closing completion position may be the same position.

In the mold opening step, the movable platen 120 is retracted by driving the mold clamping motor 160 to retract the crosshead 151 from the mold opening start position to the mold opening completion position at a set moving speed, and the movable mold 820 is separated from the stationary mold 810. Thereafter, the ejector device 200 ejects the molded product from the movable mold 820.

The set conditions for the mold closing step, the pressure increasing step, and the mold clamping step are collectively set as a series of set conditions. For example, a moving speed and a position (including a mold closing start position, a moving speed switchover position, a mold closing completion position, and a mold clamping position) of the crosshead 151 for the mold closing step and the pressure increasing step, and the mold clamping force are collectively set as a series of set conditions. A mold closing start position, a moving speed switchover position, a mold closing completion position, and a mold clamping position are arranged in this order from the rear to the front, and represent a start point and an end point of a section for which a moving speed is set. A moving speed is set for each section. The number of a moving speed switchover position may be one or more. A moving speed switchover position need not be set. Only either of a mold clamping position and a mold clamping force may be set.

The set conditions for the pressure releasing step and the mold opening step are set in the same manner. For example, a moving speed and a position (a mold opening start position, a moving speed switchover position, a mold opening completion position) of the crosshead 151 for the pressure releasing step and the mold opening step are collectively set as a series of set conditions. A mold opening start position, a moving speed switchover position, a mold opening completion position are arranged in this order from the front to the rear, and represent a start point and an end point of a section for which a moving speed is set. A moving speed is set for each section. The number of a moving speed switchover positions may be one or more. A moving speed switchover position need not be set. A mold opening start position and a mold closing completion position may be the same position. A mold opening completion position and a mold closing start position may be the same position.

Instead of a moving speed and a position of the crosshead 151, a moving speed and a position of the movable platen 120 may be set. Instead of a position of the crosshead (for example, a mold clamping position) or a position of the movable platen, a mold clamping force may be set.

The toggle mechanism 150 amplifies a driving force of the mold clamping motor 160 and transmits the amplified driving force to the movable platen 120. An amplification factor is also called a “toggle factor”. A toggle factor changes according to an angle θ formed by the first link 152 and the second link 153 (hereinafter, also referred to as a “link angle θ”). The link angle θ is obtained from the position of the crosshead 151. When the link angle θ is 180°, the toggle factor is maximized.

In the case where the thickness of the mold device 800 changes due to a replacement of the mold device 800 or a temperature change of the mold device 800, the mold thickness is adjusted so that a predetermined mold clamping force is obtained at the time of mold clamping. In the mold thickness adjustment, for example, an interval L between the stationary platen 110 and the toggle support 130 is adjusted so that the link angle θ of the toggle mechanism 150 becomes a predetermined angle at the time of the movable mold 820 touching the stationary mold 810 (or “mold touch”).

The mold clamping device 100 includes a mold thickness adjustment mechanism 180. The mold thickness adjustment mechanism 180 adjusts a mold thickness by adjusting an interval L between the stationary platen 110 and the toggle support 130. The mold thickness adjustment is performed at a timing between the end of a molding cycle and the start of a next molding cycle, for example. The mold thickness adjustment mechanism 180 includes, for example, a screw shaft 181 formed at the rear end portion of the tie bar 140, a screw nut 182 held by the toggle support 130 so as to be rotatable and not to be movable frontward and rearward, and a mold thickness adjustment motor 183 that rotates the screw nut 182 screwed to the screw shaft 181.

The screw shaft 181 and the screw nut 182 are provided for each tie bar 140. A rotational driving force of the mold thickness adjustment motor 183 may be transmitted to the plurality of screw nuts 182 via the rotational driving force transmitter 185. The plurality of screw nuts 182 can be rotated synchronously. The plurality of screw nuts 182 can be individually rotated by changing the transmission path of the rotational driving force transmitter 185.

The rotational driving force transmitter 185 is configured by, for example, a gear. In this case, a driven gear is formed on the outer periphery of each screw nut 182, a driving gear is attached to the output shaft of the mold thickness adjustment motor 183, and an intermediate gear which meshes with the plurality of driven gears and the driving gear is rotatably held at the center of the toggle support 130. The rotational driving force transmitter 185 may be configured by a belt, a pulley, or the like instead of the gear.

The operation of the mold thickness adjustment mechanism 180 is controlled by the control device 700. The control device 700 drives the mold thickness adjustment motor 183 to rotate the screw nuts 182. As a result, the position of the toggle support 130 with respect to the tie bar 140 is adjusted, and the interval L between the stationary platen 110 and the toggle support 130 is adjusted. A plurality of mold thickness adjustment mechanisms may be used in combination.

The interval L is detected by using a mold thickness adjustment motor encoder 184. The mold thickness adjustment motor encoder 184 detects a rotation amount and a rotation direction of the mold thickness adjustment motor 183 and sends a signal indicating the detection result to the control device 700. The detection result of the mold thickness adjustment motor encoder 184 is used for monitoring and controlling the position of the toggle support 130 and the interval L. The toggle support position detector for detecting the position of the toggle support 130 and the interval detector for detecting the interval L are not limited to the mold thickness adjustment motor encoder 184, and general detectors can be used.

The mold clamping device 100 may include a mold temperature regulator that controls the temperature of the mold device 800. The mold device 800 has a flow path for a temperature regulating medium therein. The mold temperature regulator controls the temperature of the mold device 800 by controlling the temperature of a temperature regulating medium supplied to the flow path of the mold device 800.

The mold clamping device 100 of the present embodiment is a horizontal type in which the mold opening/closing direction is a horizontal direction, but may be a vertical type in which the mold opening/closing direction is a vertical direction.

The mold clamping device 100 of the present embodiment includes the mold clamping motor 160 as a drive source but may include a hydraulic cylinder instead of the mold clamping motor 160. The mold clamping device 100 may include a linear motor for mold opening and closing and an electromagnet for mold clamping.

### (Ejector Device)

In the description of the ejector device 200, similarly to the descriptions of the mold clamping device 100, a moving direction of the movable platen 120 at the time of mold closing (for example, an X-axis positive direction) is defined as the front, and a moving direction of the movable platen 120 at the time of mold opening (for example, an X-axis negative direction) is defined as the rear.

The ejector device 200 is attached to the movable platen 120 and moves frontward and rearward together with the movable platen 120. The ejector device 200 includes an ejector rod 210 that ejects a molded article from the mold device 800, and a drive mechanism 220 that moves the ejector rod 210 in the moving direction (X-axis direction) of the movable platen 120.

The ejector rod 210 is disposed in a through-hole of the movable platen 120 so as to be movable frontward and rearward. The front end portion of the ejector rod 210 is in contact with the ejector plate 826 of the movable mold 820. The front end of the ejector rod 210 may be connected to the ejector plate 826 or need not be connected to the ejector plate 826.

The drive mechanism 220 includes, for example, an ejector motor and a motion conversion mechanism that converts a rotational motion of the ejector motor into a linear motion of the ejector rod 210. The motion conversion mechanism includes a screw shaft and a screw nut screwed to the screw shaft. Balls or rollers may be interposed between the screw shaft and the screw nut.

The ejector device 200 performs the ejection process under the control of the control device 700. In the ejection step, the ejector rod 210 is advanced from the standby position to the ejection position at a set moving speed, whereby the ejector plate 826 is advanced and the molded article is ejected. Thereafter, the ejector motor is driven to retract the ejector rod 210 at a set moving speed, and the ejector plate 826 is retracted to the original standby position.

The position and the moving speed of the ejector rod 210 are detected by using, for example, an ejector motor encoder. The ejector motor encoder detects a rotation of the ejector motor and sends a signal indicating the detection result to the control device 700. The ejector rod position detector for detecting the position of the ejector rod 210 and the ejector rod moving speed detector for detecting the moving speed of the ejector rod 210 are not limited to the ejector motor encoder, and general detectors can be used.

### (Injection Device)

In the descriptions of the injection device 300, unlike the descriptions of the mold clamping device 100 and the descriptions of the ejector device 200, a moving direction of the screw 330 at the time of filling (for example, the X-axis negative direction) is defined as the front, and a moving direction of the screw 330 at the time of metering (for example, the X-axis positive direction) is defined as the rear.

The injection device 300 is installed on a slide base 301, and the slide base 301 is disposed so as to be movable frontward and rearward with respect to an injection device frame 920. The injection device 300 is disposed so as to be movable frontward and rearward with respect to the mold device 800. The injection device 300 touches the mold device 800 and fills the cavity space 801 in the mold device 800 with a molding material weighted in the cylinder 310. The injection device 300 includes, for example, a cylinder 310 that heats a molding material, a nozzle 320 provided at a front end portion of the cylinder 310, a screw 330 disposed in the cylinder 310 so as to be movable frontward and rearward and rotatable, a metering motor 340 that rotates the screw 330, an injection motor 350 that moves the screw 330 frontward and rearward, and a load detector 360 that detects a load transmitted between the injection motor 350 and the screw 330.

The cylinder 310 heats the molding material supplied from a supply port 311 to the inside. The molding material includes, for example, a resin. The molding material is formed in a pellet shape, for example, and is supplied to the supply port 311 in a solid state. The supply port 311 is formed in a rear portion of the cylinder 310. A cooler 312, such as a water-cooled cylinder or the like, is provided on the outer periphery of the rear portion of the cylinder 310. A heater 313, such as a band heater or the like, and a temperature detector 314 are provided on the outer periphery of the cylinder 310 in front of the cooler 312.

The cylinder 310 is divided into a plurality of zones in the axial direction (for example, the X-axis direction) of the cylinder 310. The heater 313 and the temperature detector 314 are provided in each of the plurality of zones. A set temperature is set for each of the zones, and the control device 700 controls the heater 313 so that the temperature detected by the temperature detector 314 reaches the set temperature.

The nozzle 320 is provided at the front end portion of the cylinder 310 and is pressed against the mold device 800. The heater 313 and the temperature detector 314 are provided on the outer periphery of the nozzle 320. The control device 700 controls the heater 313 so that the temperature detected by the nozzle 320 reaches the set temperature.

The screw 330 is disposed in the cylinder 310 so as to be rotatable and movable frontward and rearward. As the screw 330 is rotated, a molding material is pushed frontward along the spiral groove of the screw 330. The molding material is gradually melted by the heat from the cylinder 310 while being pushed frontward. As the liquid molding material is pushed to the front of the screw 330 and accumulated in the front portion of the cylinder 310, the screw 330 is retracted. Thereafter, as the screw 330 is advanced, the liquid molding material accumulated in front of the screw 330 is injected from the nozzle 320 and is filled into the mold device 800.

A backflow prevention ring 331 is attached to the front portion of the screw 330 so as to be movable frontward and rearward as a backflow prevention valve that prevents backflow of a molding material from the front to the rear of the screw 330 at the time of pushing the screw 330 frontward.

When the screw 330 is advanced, the backflow prevention ring 331 is pushed rearward by the pressure of the molding material in front of the screw 330, and is retracted relative to the screw 330 to a closure position (see FIG. 2) at which the backflow prevention ring 331 closes the flow path of the molding material. This prevents the molding material accumulated in front of the screw 330 from flowing rearward.

On the other hand, when the screw 330 is rotated, the backflow prevention ring 331 is pushed frontward by the pressure of the molding material pushed frontward along the spiral groove of the screw 330, and is advanced relative to the screw 330 to a release position (see FIG. 1) at which the backflow prevention ring 331 opens the flow path of the molding material. Thus, the molding material is pushed to the front of the screw 330.

The backflow prevention ring 331 may be either a co-rotation type that rotates together with the screw 330 or a non-co-rotation type that does not rotate together with the screw 330.

The injection device 300 may include a drive source that moves the backflow prevention ring 331 frontward and rearward between the release position and the closure position with respect to the screw 330.

The metering motor 340 rotates the screw 330. The drive source for rotating the screw 330 is not limited to the metering motor 340, and may be, for example, a hydraulic pump.

The injection motor 350 moves the screw 330 frontward and rearward. A motion conversion mechanism or the like for converting a rotational motion of the injection motor 350 into a linear motion of the screw 330 is provided between the injection motor 350 and the screw 330. The motion conversion mechanism includes, for example, a screw shaft and a screw nut screwed to the screw shaft. Balls, rollers, or the like may be provided between the screw shaft and the screw nut. The drive source for advancing and retracting the screw 330 is not limited to the injection motor 350, and may be, for example, a hydraulic cylinder.

The load detector 360 detects a load transmitted between the injection motor 350 and the screw 330. The detected load is converted into a pressure by the control device 700. The load detector 360 is provided in a load transmission path between the injection motor 350 and the screw 330, and detects a load acting on the load detector 360.

The load detector 360 sends a signal of the detected load to the control device 700. The load detected by the load detector 360 is converted into a pressure acting between the screw 330 and a molding material, and is used for controlling or monitoring a pressure received by the screw 330 from a molding material, a back pressure to the screw 330, a pressure acting on a molding material from the screw 330, and the like.

A pressure detector for detecting the pressure of a molding material is not limited to the load detector 360, and a general pressure detector can be used. For example, a nozzle pressure sensor or a mold internal pressure sensor may be used. The nozzle pressure sensor is installed at the nozzle 320.

The injection device 300 performs a metering step, a filling step, a hold pressure step, and the like under the control of the control device 700. The filling step and the hold pressure step may be collectively referred to as an “injection step”.

In the metering step, the metering motor 340 is driven to rotate the screw 330 at a set rotation speed, and the molding material is pushed frontward along the spiral groove of the screw 330. As a result, the molding material is gradually melted. As the liquid molding material is pushed to the front of the screw 330 and accumulated in the front portion of the cylinder 310, the screw 330 is retracted. The rotation speed of the screw 330 is detected by using, for example, the metering motor encoder 341. The metering motor encoder 341 detects the rotation of the metering motor 340 and sends a signal indicating the detection result to the control device 700. A screw rotational speed detector for detecting the rotational speed of the screw 330 is not limited to the metering motor encoder 341, and a general detector can be used.

In the metering step, in order to suppress a rapid retreat of the screw 330, the injection motor 350 may be driven to apply a set back pressure to the screw 330. The back pressure to the screw 330 is detected by using, for example, the load detector 360. When the screw 330 is retracted to a metering completion position and a predetermined amount of the molding material is accumulated in front of the screw 330, the metering step is completed.

A position and a rotation speed of the screw 330 for the metering step are collectively set as a series of set conditions. For example, a metering start position, a rotational speed switchover position, and a metering completion position are set. These positions are arranged in this order from the front to the rear, and represent the start point and the end point of a section for which a rotation speed is set. A rotation speed is set for each section. The number of a rotation speed switchover position may be one or more. A rotation speed switchover position need not be set. A back pressure is set for each section.

In the filling step, the injection motor 350 is driven to move the screw 330 frontward at a set moving speed, and a liquid molding material accumulated in front of the screw 330 is filled in the cavity space 801 in the mold device 800. The position and the moving speed of the screw 330 are detected by using, for example, the injection motor encoder 351. The injection motor encoder 351 detects the rotation of the injection motor 350 and sends a signal indicating the detection result to the control device 700. When the position of the screw 330 reaches a set position, changeover from the filling step to the hold pressure step (so-called V/P switchover) is performed. The position where the V/P switchover is performed is also referred to as a “V/P switchover position”. A set moving speed of the screw 330 may be changed according to the position of the screw 330, time, or the like.

A position and a moving speed of the screw 330 for the filling step are collectively set as a series of set conditions. For example, a filling start position (also referred to as an “injection start position”), a moving speed switchover position, and a V/P switchover position are set. These positions are arranged in this order from the rear to the front, and represent the start point and the end point of a section for which a rotation speed is set. A moving speed is set for each section. The number of a moving speed switchover position may be one or more. A moving speed switchover position need not be set.

An upper limit value of the pressure of the screw 330 is set for each section for which a moving speed of the screw 330 is set. The pressure of the screw 330 is detected by the load detector 360. In the case where the pressure of the screw 330 is equal to or lower than the set pressure, the screw 330 is moved frontward at the set moving speed. On the other hand, in the case where the pressure of the screw 330 exceeds the set pressure, for the purpose of protecting the mold, the screw 330 is advanced at a moving speed lower than the set moving speed so that the pressure of the screw 330 becomes equal to or lower than the set pressure.

Note that, after the position of the screw 330 reaches the V/P switchover position in the filling step, the screw 330 may be temporarily stopped at the V/P switchover position, and then V/P switchover may be performed. Immediately before V/P switchover, the screw 330 may be advanced or retracted at a very low speed instead of stopping the screw 330. A screw position detector for detecting the position of the screw 330 and a screw moving speed detector for detecting the moving speed of the screw 330 are not limited to the injection motor encoder 351, and general detectors can be used.

In the hold pressure step, the injection motor 350 is driven to push the screw 330 frontward, and the pressure of a molding material at the front end portion of the screw 330 (hereinafter, also referred to as a “held pressure”) is remained at the set pressure, and the molding material remaining in the cylinder 310 is pushed toward the mold device 800. The molding material can be thus replenished by the shortage due to cooling shrinkage in the mold device 800. The held pressure is detected by using, for example, the load detector 360. The set value of the held pressure may be changed according to a length of time elapsed from the start of the hold pressure step. A plurality of held pressures and durations during which a held pressure is maintained in the hold pressure step may be set, and may be collectively set as a series of set conditions.

In the hold pressure step, a molding material in the cavity space 801 in the mold device 800 is gradually cooled, and when the hold pressure step is completed, the inlet of the cavity space 801 is closed by the solidified molding material. This state is called a “gate seal”, and a backflow of the molding material from the cavity space 801 is prevented. After the hold pressure step, the cooling step is started. In the cooling step, the molding material in the cavity space 801 is solidified. In order to shorten a molding cycle time, a metering step may be performed during the cooling step.

The injection device 300 of the present embodiment is of an inline screw type but may be of a pre-plasticization type. A pre-plasticizing injection device supplies a molding material melted in a plasticizing cylinder to an injection cylinder, and injects the molding material from the injection cylinder into a mold device. In the plasticizing cylinder, a screw is disposed rotatably and unmovably frontward and rearward, or a screw is disposed rotatably and movably frontward and rearward. On the other hand, a plunger is disposed in the injection cylinder so as to be movable frontward and rearward.

The injection device 300 of the present embodiment is a horizontal type in which the axial direction of the cylinder 310 is the horizontal direction, but may be a vertical type in which the axial direction of the cylinder 310 is the vertical direction. The mold clamping device combined with the vertical injection device 300 may be a vertical type or a horizontal type. Similarly, the mold clamping device combined with the vertical injection device 300 may be a vertical type or a horizontal type.

### (Moving Device)

In the descriptions of the moving device 400, similarly to the descriptions of the injection device 300, a moving direction of the screw 330 at the time of filling (for example, the X-axis negative direction) is defined as the front, and a moving direction of the screw 330 at the time of metering (for example, the X-axis positive direction) is defined as the rear.

The moving device 400 advances and retracts the injection device 300 with respect to the mold device 800. The moving device 400 presses the nozzle 320 against the mold device 800 to generate a nozzle touch pressure. The moving device 400 includes a hydraulic pump 410, a motor 420 as a drive source, a hydraulic cylinder 430 as a hydraulic actuator, and the like.

The hydraulic pump 410 has a first port 411 and a second port 412. The hydraulic pump 410 is a pump capable of rotating in both directions, and generates a hydraulic pressure by switching the rotation direction of the motor 420 to suck a working liquid (for example, oil) from either of the first port 411 and the second port 412 and discharge the liquid from the other. The hydraulic pump 410 can also suck a working liquid from the tank and discharge the working liquid from either of the first port 411 and the second port 412.

The motor 420 operates the hydraulic pump 410. The motor 420 drives the hydraulic pump 410 in a rotational direction and with a rotational torque corresponding to a control signal from the control device 700. The motor 420 may be an electric motor or an electric servo motor.

The hydraulic cylinder 430 includes a cylinder main body 431, a piston 432, and a piston rod 433. The cylinder main body 431 is fixed to the injection device 300. The piston 432 divides the interior of the cylinder main body 431 into a front chamber 435 as a first chamber and a rear chamber 436 as a second chamber. The piston rod 433 is fixed relative to the stationary platen 110.

The front chamber 435 of the hydraulic cylinder 430 is connected to the first port 411 of the hydraulic pump 410 via a first flow path 401. The working liquid discharged from the first port 411 is supplied to the front chamber 435 via the first flow path 401, and thus the injection device 300 is pushed frontward. The injection device 300 is advanced, and the nozzle 320 is pressed against the stationary mold 810. The front chamber 435 functions as a pressure chamber that generates a nozzle touch pressure of the nozzle 320 by the pressure of the working liquid supplied from the hydraulic pump 410.

The rear chamber 436 of the hydraulic cylinder 430 is connected to the second port 412 of the hydraulic pump 410 via a second flow path 402. The working liquid discharged from the second port 412 is supplied to the rear chamber 436 of the hydraulic cylinder 430 via the second flow path 402, and thus the injection device 300 is pushed rearward. The injection device 300 is retracted, and the nozzle 320 is separated from the stationary mold 810.

In the present embodiment, the moving device 400 includes the hydraulic cylinder 430, but the present invention is not limited to this example. For example, instead of the hydraulic cylinder 430, an electric motor and a motion conversion mechanism that converts the rotational motion of the electric motor into the linear motion of the injection device 300 may be used.

### (Control Device)

The control device 700 is configured by, for example, a computer, and includes a central processing unit (CPU) 701, a storage medium 702 such as a memory, an input interface 703, an output interface 704, and an communication interface 705 as illustrated in FIGS. 1 and 2. The control device 700 performs various controls by causing the CPU 701 to execute programs stored in the storage medium 702. The control device 700 receives a signal from an external device through the input interface 703 and transmits a signal to an external device through the output interface 704.

The control device 700 repeatedly performs the metering step, the mold closing step, the pressure increasing step, the mold clamping step, the filling step, the hold pressure step, the cooling step, the pressure releasing step, the mold opening step, the ejection step, and the like, thereby repeatedly producing a molded product. A series of operations for obtaining a molded article, for example, an operation from the start of the metering step to the start of the next metering step is also referred to as a “shot” or a “molding cycle”. A time required for one shot is referred to as a “molding cycle time” or a “cycle time”.

One molding cycle includes, for example, a metering step, a mold closing step, a pressure increasing step, a mold clamping step, a filling step, a hold pressure step, a cooling step, a pressure releasing step, a mold opening step, and an ejection step in this order. The order here is the order of the start of each step. The filling step, the hold pressure step, and the cooling step are performed during the mold clamping step. The start of the mold clamping step may coincide with the start of the filling step. The completion of the pressure releasing step coincides with the start of the mold opening step.

In order to shorten a molding cycle time, a plurality of steps may be performed at the same time. For example, the metering step may be performed during the cooling step of the previous molding cycle, or may be performed during the mold clamping step. In this case, the mold closing step may be performed at the beginning of the molding cycle. The filling step may be started during the mold closing step. The ejection step may be started during the mold opening step. In the case where an opening/closing valve that opens and closes the flow path of the nozzle 320 is provided, the mold opening process may be started during the metering process. This is because even if the mold opening step is started during the metering step, a molding material does not leak from the nozzle 320 as long as the opening/closing valve closes the flow path of the nozzle 320.

One molding cycle may include a step other than the metering step, the mold closing step, the pressure increasing step, the mold clamping step, the filling step, the hold pressure step, the cooling step, the pressure releasing step, the mold opening step, and the ejection step.

For example, after the completion of the hold pressure step, before the start of the metering step, a pre-metering suck back process of retracting the screw 330 to a predetermined metering start position may be performed. This reduces the pressure of a molding material accumulated in front of the screw 330 before the start of the metering step, and a rapid retreat of the screw 330 at the start of the metering process can be thereby prevented.

After the completion of the metering step yet before the start of the filling step, a post-metering suck back step may be performed after the metering to retract the screw 330 to a preset filling start position (also referred to as an “injection start position”). This reduces the pressure of a molding material accumulated in front of the screw 330 before the start of the filling step, and a leakage of the molding material from the nozzle 320 before the start of the filling step can be thereby prevented.

The control device 700 is connected to an operation device 750 that receives an input operation by a user and a display device 760 on which a screen is displayed. The operation device 750 and the display device 760 may be configured by, for example, a touch panel 770 and may be integrated. The touch panel 770 as the display device 760 is caused to display a screen under the control of the control device 700. For example, information, such as setting of the injection molding machine 10 and a current state of the injection molding machine 10, may be displayed on the screen of the touch panel 770. The touch panel 770 is configured to accept an operation in the displayed screen area. On the screen area of the touch panel 770, an operation unit, such as a button or an input field for receiving an input operation by a user, may be displayed, for example. The touch panel 770 as the operation device 750 detects an input operation on the screen by a user and outputs a signal corresponding to the input operation to the control device 700. Thus, for example, a user can perform setting (including input of a set value) of the injection molding machine 10 by operating the operation unit provided on the screen while checking information displayed on the screen. A user's operation of the operation unit provided on the screen can cause the injection molding machine 10 to perform an operation corresponding to the operation. The operation of the injection molding machine 10 may be, for example, an operation (including stopping) of the mold clamping device 100, the ejector device 200, the injection device 300, the moving device 400, or the like. The operation of the injection molding machine 10 may be switching of a screen displayed on the touch panel 770 as the display device 760.

Note that the operation device 750 and the display device 760 of the present embodiment are described as being integrated as the touch panel 770, but may be provided separately. A plurality of operation devices 750 may be provided. The operation device 750 and the display device 760 are disposed on the operation side (Y-axis negative direction) of the mold clamping device 100 (more specifically, the stationary platen 110).

### First Embodiment

There is a requirement to implement abnormality detection using a trained model during injection molding. In this case, it is necessary to perform machine learning to generate a trained model.

It can be considered possible to perform the training phase of machine learning through training in the injection molding machine. However, this requires the processing equipment of the injection molding machine to have high processing capability. Therefore, an information processing apparatus, instead of the injection molding machine, can perform training.

In the present embodiment, an example of performing the training phase and the inference phase in different apparatuses will be described. Specifically, a trained model created in the training phase of the machine learning apparatus is mounted on the injection molding machine. Although the method of performing the training phase and the inference phase in separate apparatuses will be described, the present embodiment is not limited to this example, and the training phase and the inference phase may be performed in the same apparatus.

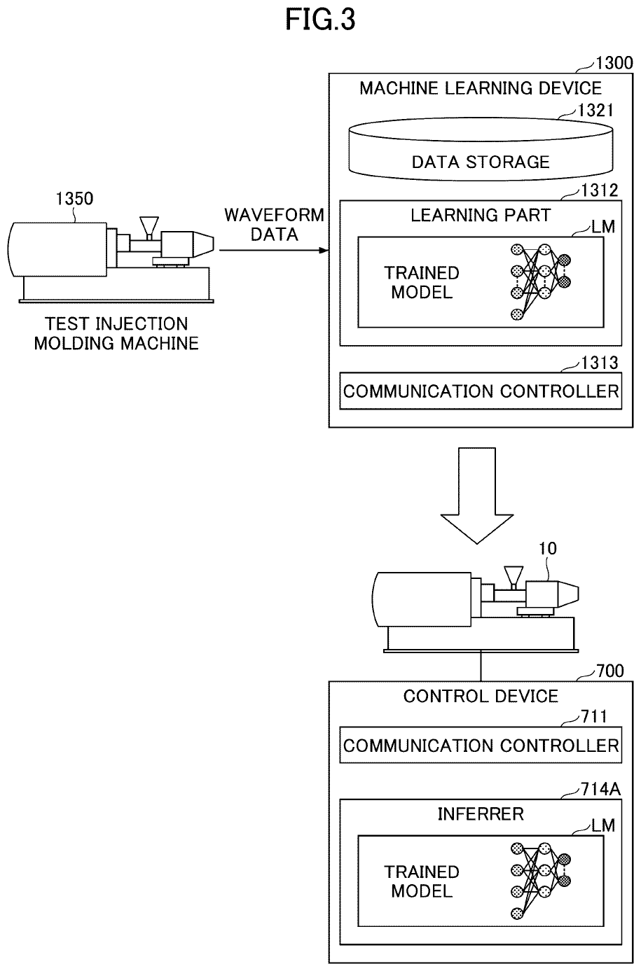

FIG. 3 is a conceptual diagram illustrating cooperation between the machine learning device and the control device for the injection molding machine according to the present embodiment through use of a trained model.

In the example illustrated in FIG. 3, a test injection molding machine 1350, a machine learning device 1300, and the control device 700 of the injection molding machine 10 are illustrated.

In the example illustrated in FIG. 3, the test injection molding machine 1350 and the machine learning device 1300 may be owned by, for example, a producer of the injection molding machine 10, a shipping destination of the injection molding machine, or a service provider that generates the trained model.

The test injection molding machine 1350 is an injection molding machine used for machine learning. The configuration of the test injection molding machine 1350 is the same as that of the injection molding machine 10, and a description thereof is omitted. If the shipping destination owns the machine learning device 1300, the injection molding machine 10 is used instead of the test injection molding machine 1350.

The test injection molding machine 1350 according to the present embodiment molds a molded article (an example of a product) according to a setting by a user. The test injection molding machine 1350 outputs waveform data measured during injection molding to the machine learning device 1300. In the present embodiment, data indicating the result detected by the detection device provided in the test injection molding machine 1350 or the injection molding machine 10 in time series is hereinafter referred to as “waveform data” (an example of time-series data).

The machine learning device 1300 stores the input waveform data in the data storage 1321.

The machine learning device 1300 performs the training phase. For this purpose, the learning part 1312 of the machine learning device 1300 causes a neural network to read data stored in the data storage 1321, and generates, as a trained model LM, a network in which synaptic weights and biases are adjusted.

For example, the learning part 1312 of the machine learning device 1300 generates a trained model LM by reading a large amount of waveform data and performing machine learning by an error back-propagation method using a neural network.

The machine learning device 1300 may be, for example, an on-premises server installed in a factory or the like, or a cloud server. Furthermore, the machine learning device 1300 may be a stationary terminal device installed in a factory or the like, or a portable terminal device (portable device). The stationary terminal device may include, for example, a desktop PC (personal computer). The portable terminal device may include, for example, a smartphone, a tablet device, a laptop PC, and the like.

The control device 700 of the injection molding machine 10 performs the inference phase. The inferrer 714A of the control device 700 inputs waveform data indicating the result detected by the detection device provided in the injection molding machine 10 in time series to the trained model LM, and causes the trained model IM to perform inference. The control device 700 detects an abnormality based on the output result from the trained model LM.

In the present embodiment, the learning part 1312 of the machine learning device 1300 generates the trained model LM, and the communication controller 1313 transfers the generated trained model LM to the control device 700 using a communication interface. The present embodiment is not limited to a mode in which the trained model LM itself is transferred, and the weight and bias of the trained model LM may be transferred to the control device 700. By updating the trained model LM based on the received weight and bias, the control device 700 can match the trained model LM to the trained model LM of the learning part 1312 of the machine learning device 1300.

Thus, the communication controller 711 of the control device 700 receives the trained model LM, and the inferrer 714A makes an inference using the trained model LM generated in the training phase of the machine learning device 1300. Next, the configurations of the machine learning device 1300 and the control device 700 will be described.

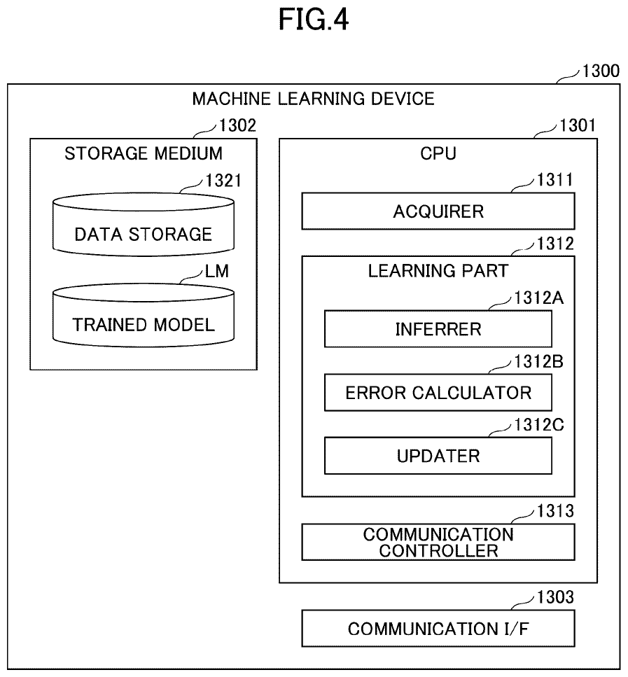

FIG. 4 is a diagram illustrating an example of a functional configuration of the machine learning device 1300 according to the present embodiment. The functions of the machine learning device 1300 are realized by freely chosen hardware, a combination of freely selected hardware and software, or the like. For example, as illustrated in FIG. 4, the machine learning device 1300 includes a CPU 1301, a storage medium 1302, and a communication interface 1303.

The storage medium 1302 stores the installed various programs, and also stores files, data, and the like necessary for various processes. The storage medium 1302 includes, for example, a hard disk drive (HDD), a solid state drive (SSD), a flash memory, or the like.

The storage medium 1302 according to the present embodiment includes a data storage 1321 and a trained model LM. The data storage 1321 stores training data to be used for training the trained model LM.

The communication interface 1303 is used as an interface for connecting to an external device so as to be able to communicate with an external device. Thus, the machine learning device 1300 can communicate with an external device, such as an injection molding machine 10, through the communication interface 1303. The communication interface 1303 may include a plurality of types of communication interfaces depending on a communication method with a device to be connected.

The CPU 1301 of the machine learning device 1300 executes a program stored in the storage medium 1302. Thus, the CPU 1301 includes an acquirer 1311, a learning part 1312, and a communication controller 1313 as functional units.

First, a configuration for generating a trained model LM by the machine learning device 1300 will be described.

The acquirer 1311 acquires waveform data indicating a detection result by the detection device provided in the test injection molding machine 1350 from the test injection molding machine 1350, and stores the acquired waveform data in the data storage 1321. The detection result acquired from the detection device is, for example, time-series data of the pressure received from the molding material detected by the load detector 360. In the present embodiment, the detection result acquired from the detection device is not limited to time-series data of a pressure received from a molding material, but may be time-series data of other physical quantities, such as a position, speed, or torque of a configuration included in the test injection molding machine 1350. Furthermore, time-series data of a detection result by a detection device provided inside or outside the test injection molding machine 1350 may be used. The present embodiment is not limited to the mode of using one type of time-series data, and a plurality of types of time-series data may be used. For example, in the case of using time-series data of the torque generated when the movable platen 120 is moved by opening and closing the mold, it is possible to detect an abnormality concerning the contamination of the mold device 800 or the mold clamping device 100.

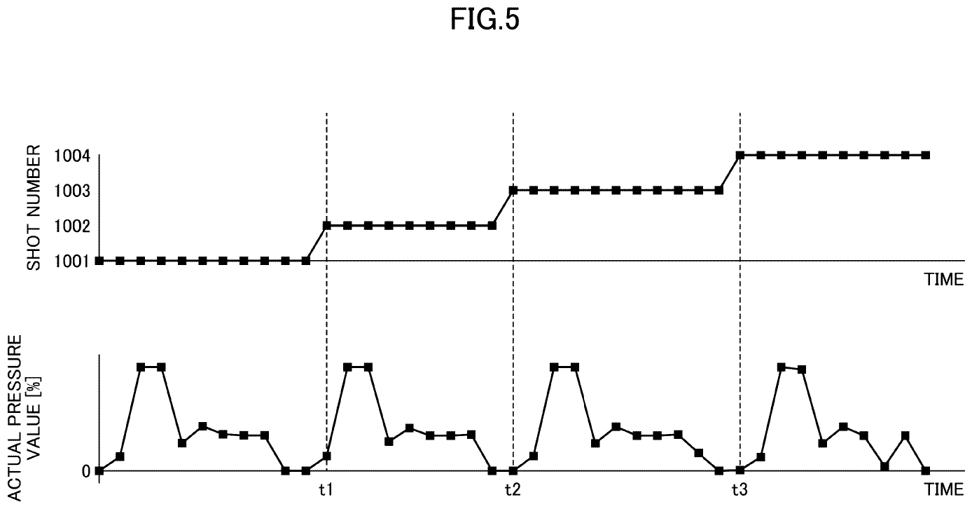

FIG. 5 is a diagram illustrating an example of waveform data of pressure values (hereinafter “actual pressure values”) as a result detected by the load detector 360 provided in the test injection molding machine 1350 or the injection molding machine 10 according to the present embodiment. The example illustrated in FIG. 5 illustrates the time-series change of the actual pressure value and the shot number acquired by the load detector 360 incorporated in the test injection molding machine 1350 or the injection molding machine 10 during molding. In the example illustrated in FIG. 5, the shot number increases at times t1, t2, and t3. In the example illustrated in FIG. 5, the detection cycle is one second, but an appropriate cycle may be set according to the embodiment.

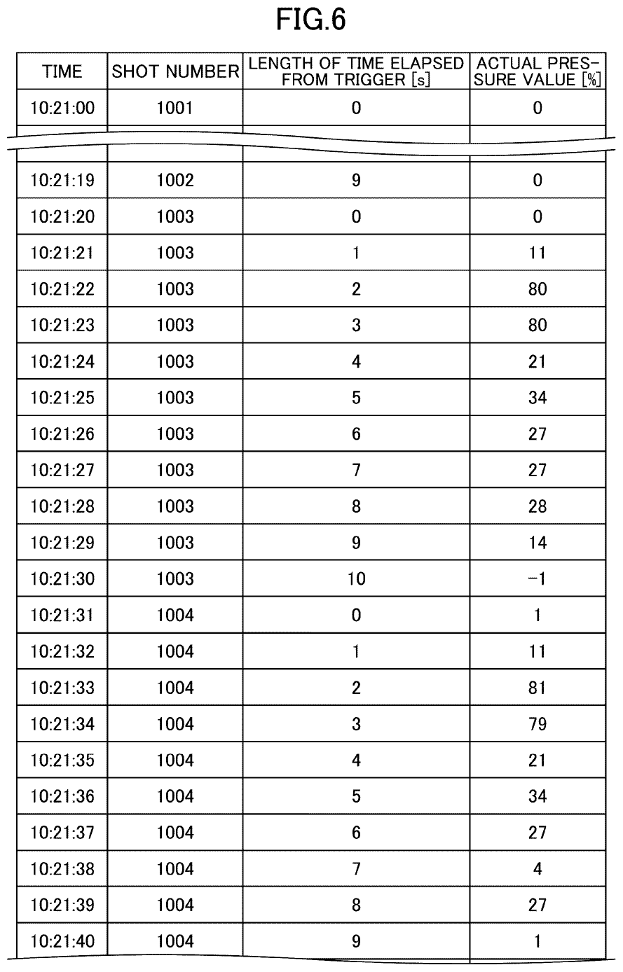

FIG. 6 is a diagram illustrating actual pressure values, in a table form, as a result detected by the load detector 360 provided in the test injection molding machine 1350 or the injection molding machine 10 according to the present embodiment. In the example illustrated in FIG. 6, a time, a shot number, a length of time elapsed from the trigger, and an actual pressure value are indicated in association with each other. For example, the trigger is set at the timing of switching the molding process, such as the start of mold closing or the start of injection. In other words, a length of time elapsed from a trigger according to the present embodiment is a length of time elapsed from the timing of switching the molding process, such as the start of mold closing or the start of injection, but a length of time elapsed from a freely determined timing of process switching may be set, or a length of time elapsed since the shot number is switched. The actual pressure value is the actual pressure value obtained (measured) by the load detector 360. In the present embodiment, the test injection molding machine 1350 and the injection molding machine 10 manage the switching of the process. The acquirer 1311 according to the present embodiment thus ascertains the switching of the process by the communication from the test injection molding machine 1350 or the injection molding machine 10 and collects information by using the switching of the process as a trigger. Therefore, in the present embodiment, it is possible to align the timing for collecting information.

For example, the acquirer 1311 acquires the detection result by the detection device, such as the load detector 360, as an actual pressure value for each detection cycle starting from the trigger timing for each shot, and stores it in the data storage 1321 in association with a time, a shot number, and a length of time elapsed from the trigger. Alternatively, the acquirer 1311 may constantly take in the sensor signal, and store the data (for example, the actual pressure value) detected when the process is switched in association with a time, a shot number, and a length of time elapsed from the trigger. In the test injection molding machine 1350 and the injection molding machine 10 according to the present embodiment, the detection result by the detection device, such as the load detector 360, is buffered. The buffered data is not limited to the data after the trigger timing but also includes the data before the trigger timing. For example, as a waveform function, in the case of buffering 550 points of data, the test injection molding machine 1350 and the injection molding machine 10 have 50 points of data before the trigger timing and 500 points of data after the trigger timing. In other words, if data targeted for buffering after the trigger timing is 100%, the test injection molding machine 1350 and the injection molding machine 10 buffer only 10% of the data before the trigger timing. As described above, the present embodiment acquires data starting from the trigger, but the trigger timing is not limited to the start point of the waveform data.

The acquirer 1311 acquires waveform data (an example of time-series data) indicating the pressure detected by the load detector 360 from the test injection molding machine 1350 each time a molded article is molded. In the present embodiment, the waveform data to be acquired is not limited to waveform data indicating the pressure detected by the load detector 360 from the beginning to the end of the molding cycle, but may be waveform data indicating the detection result for each shot. For example, the waveform data to be acquired may be waveform data indicating a part or the entirety of a molding cycle, or may be waveform data covering the preceding or following shots.

The waveform data stored in the data storage 1321 by the acquirer 1311 according to the present embodiment is waveform data detected by the detection device (for example, the load detector 360) when a normal molded article is molded in the test injection molding machine 1350 or the injection molding machine 10. In other words, in the present embodiment, the waveform data stored in the data storage 1321 does not include waveform data in the event of an abnormality.

FIGS. 5 and 6 illustrate that the cycle time per shot for molding a molded article is 10 to 11 seconds. In the present embodiment, waveform data indicating the results detected by the detection device in time series is input for each shot to the input layer of the trained model LM.

The trained model LM according to the present embodiment is an encoder-decoder model having an encoder and a decoder based on an input layer, one or two or more intermediate layers connected to the input layer, and an output layer connected to the intermediate layer. The encoder realizes a function of extracting important features from input time-series data, and the decoder realizes a function of generating time-series data based on the features extracted by the encoder.

The present embodiment describes an example in which the trained model LM functions as an autoencoder. However, the present embodiment is not limited to an example in which the trained model LM functions as an autoencoder, and any machine learning model may be a machine learning model in which machine learning is performed to infer time-series data as a result detected by the detection device for each shot in the injection molding machine 10. The trained model LM according to the present embodiment functions to output waveform data that matches the input waveform data when normal waveform data is input. For example, when waveform data of pressure for each shot is input, the trained model LM outputs waveform data inferred as time-series data as a result detected by the detection device in a time zone corresponding to the input waveform data. The present embodiment is not limited to an example in which a machine learning model functioning as an autoencoder is used, and for example, a convolutional autoencoder, a variational autoencoder (VAE), a generative adversarial networks (GAN), a Flow-based model, a diffusion model, or other generative models may be used.

Data that is input to the input layer of the trained model LM according to the present embodiment and data that is output from the output layer have a fixed data size. Therefore, for example, waveform data of an actual pressure value of 10 seconds (10 points) as one shot is input to the trained model LM, and the trained model LM outputs waveform data of an actual pressure value of 10 seconds (10 points) as an inference result of one shot. Although the present embodiment illustrates an example of inputting an actual pressure value of 10 points as an example of a fixed length, the present embodiment does not limit the data size, and the data size may be 9 points or less or 11 points or more. In the machine learning device 1300 according to the present embodiment, the triggers for collecting data for machine learning are synchronized, and the data size used for machine learning is set to a fixed length; as a result, the data for each shot required for training the trained model LM can be aligned. Therefore, the machine learning device 1300 according to the present embodiment can improve the training accuracy for generating the trained model LM.

The learning part 1312 includes an inferrer 1312A, an error calculator 1312B, and an updater 1312C, and generates the trained model LM by performing machine learning using the waveform data stored in the data storage 1321 so that, when the waveform data stored in the data storage 1321 is input, the waveform data (an example of second time-series data) identical to the waveform data (an example of first time-series data) stored in the data storage 1321 is output. The waveform data stored in the data storage 1321 is waveform data for one shot when a molded article is normally molded by the test injection molding machine 1350 or the injection molding machine 10. The learning part 1312 stores the generated trained model LM in the storage medium 1302.

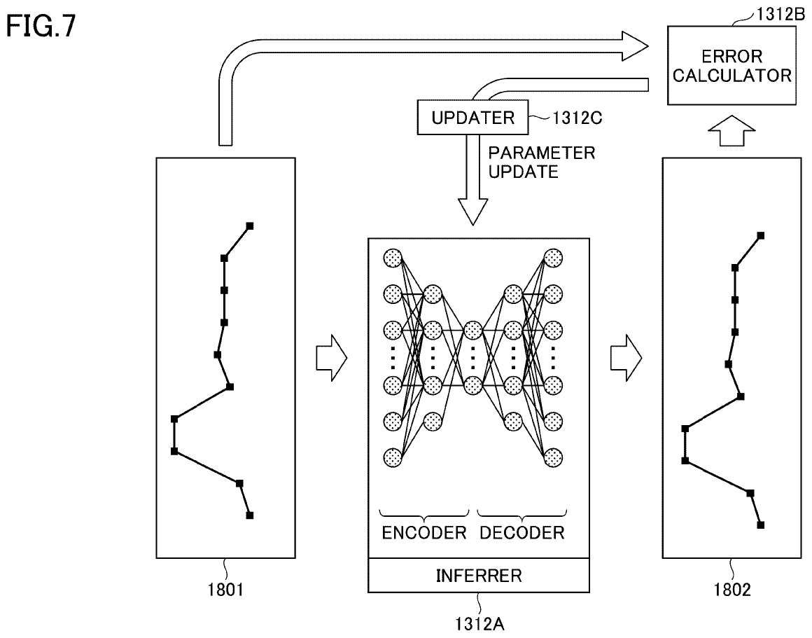

FIG. 7 is a diagram for explaining a concept of machine learning by the learning part 1312 according to the present embodiment. As illustrated in FIG. 7, the inferrer 1312A inputs waveform data 1801 stored in the data storage 1321 to a neural network having an encoder and a decoder, and receives waveform data 1802 having the same data size (data length) as the input waveform data 1801 from the neural network. A neural network having an encoder and a decoder serves as a base of the trained model LM.

The inferrer 1312A uses waveform data including actual pressure values for 10 seconds (10 points) as waveform data 1801 to be input to the neural network. Therefore, when the actual pressure value for 11 seconds (11 points) is detected as one shot, the inferrer 1312A removes the actual pressure value for the last 1 second (1 point) and inputs the waveform data of the actual pressure value for 10 points to the neural network.

Then, the error calculator 1312B calculates an error between the input waveform data 1801 and the output waveform data 1802. As a method for calculating an error, well-known methods, such as root mean square error (RMSE), mean square error (MSE), mean absolute error (MAE), and cosine similarity, may be used, and in the present embodiment, MSE (mean square error) is used.

The updater 1312C updates the parameters of the neural network based on the error calculated by the error calculator 1312B. For example, the updater 1312C updates the parameters of the neural network so that the output waveform data 1802 matches the input waveform data 1801. The parameter updating method may be a well-known method, such as an inverse error propagation method.

The learning part 1312 repeats the processing illustrated in FIG. 7 as many times as the waveform data stored in the data storage 1321 to generate the trained model LM, which is stored in the storage medium 1302.

As described above, the learning part 1312 according to the present embodiment performs machine learning by calculating and updating an amount of change of the parameter related to each node included in the neural network from the error of the output value (waveform data as the inference result) with respect to the input value (waveform data) of one shot. In the present embodiment, the data to be compared with the output value (waveform data as the inference result) used for calculating the error is the input waveform data. The trained model LM generated in this manner is a model that outputs the same waveform data as the input when the waveform data of one shot is input and the waveform data is normal. In the present embodiment, by using such a learning method, it is not necessary to prepare a correct value, and machine learning can be performed only with time-series data as the result detected by the detection device.

The trained model LM may be updated by being additionally trained with a new set of waveform data to the existing trained model LM.

In this example, the learning part 1312 is provided with a preprocessor (not illustrated) for performing standardization or normalization on the waveform data before inference is performed by the inferrer 1312A. The preprocessor may perform at least one of missing value processing or resampling in addition to standardization or normalization. For example, the preprocessor according to the present embodiment may divide the actual pressure value used as waveform data, etc. by a predetermined pressure value, and may perform preprocessing so that the actual pressure value falls within a range of 1.0.

Returning to FIG. 4, the communication controller 1313 transmits and receives information to and from an external device, such as the injection molding machine 10, using the communication interface (I/F) 1303. For example, the communication controller 1313 may transmit the trained model LM stored in the storage medium 1302 to the control device 700 of the injection molding machine 10. The communication controller 1313 may extract information indicating a structure indicating parameters (e.g., weights and biases) that is set in each layer constituting the trained model LM, and transmit the structure to the control device 700.

In this manner, the machine learning device 1300 prepares sets of waveform data based on various molding conditions provided in the test injection molding machine 1350 or the injection molding machine 10 and various mold devices provided in the test injection molding machine 1350 or the injection molding machine 10. The machine learning device 1300 performs machine learning using the waveform data sets to generate the trained model LM. Thus, inference using the trained model LM can be performed regardless of the molding conditions and the type of the mold device 800.

Therefore, in the control device 700 of the injection molding machine 10, abnormality detection using the trained model IM can be realized regardless of the mold device 800 provided and the molding conditions set.

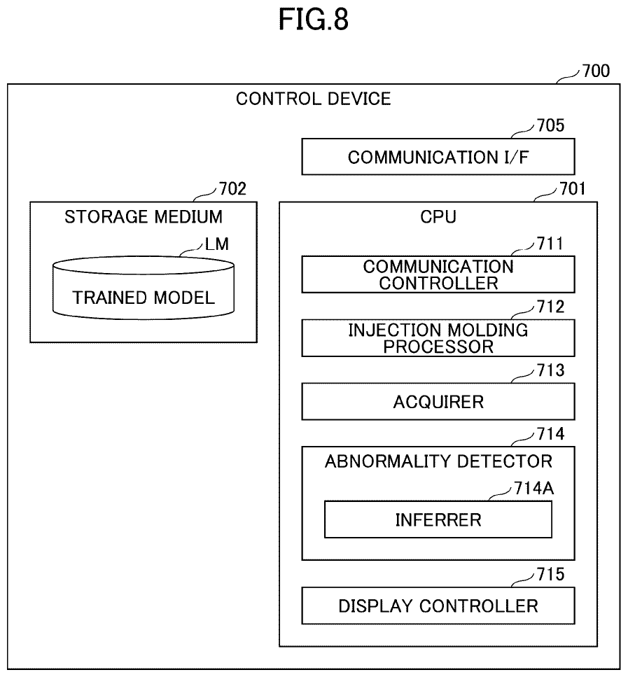

FIG. 8 is a diagram illustrating an example of a functional configuration of the control device 700 of the injection molding machine 10 according to the present embodiment. The functional blocks illustrated in FIG. 8 are conceptual and need not be physically configured as illustrated in the figure. All or some of the functional blocks may be configured to be functionally or physically distributed or integrated into freely determined units. All or any part of the processing functions performed by the functional blocks may be implemented by a program executed by the CPU 701. Alternatively, the functional blocks may be implemented as hardware by wired logic. As illustrated in FIG. 8, the CPU 701 of the control device 700 includes a communication controller 711, an injection molding processor 712, an acquirer 713, an abnormality detector 714, and a display controller 715. The control device 700 includes a trained model LM in the storage medium 702. The trained model LM has the same parameters and the like as the trained model LM stored in the storage medium 1302 of the machine learning device 1300.

The communication controller 711 uses the communication interface 705 to transmit and receive information to and from an external device, such as the machine learning device 1300. For example, the communication controller 711 may receive the trained model LM from the machine learning device 1300. The communication controller 711 may receive information indicating a structure indicating parameters (e.g., weights and biases) that is set in each layer constituting the trained model LM.

Although an example in which the trained model LM or the information indicating the structure is received from the machine learning device 1300 has been described in the present embodiment, the method for acquiring the trained model LM or the information indicating the structure is not limited to this example. For example, the trained model LM or the information indicating the structure may be acquired via an external storage medium.

In the case where the communication controller 711 receives the information indicating the structure of the trained model LM, the trained model LM stored in the storage medium 702 may be updated.

The injection molding processor 712 executes processing for forming a molded article in the injection molding machine 10. For example, when forming a molded article, the injection molding processor 712 may perform injection molding after setting each item constituting a molding condition.

The acquirer 713 acquires waveform data (an example of first time-series data) indicating a detection result by a detection device provided in the injection molding machine 10 in time series for each shot in which the molded article is molded by the injection molding machine 10. In the present embodiment, time-series data indicating a pressure received from a molding material in time series detected by the load detector 360, which is an example of a detection device, is used as waveform data to be acquired. In the present embodiment, the detection result acquired from the detection device for detecting an abnormality is not limited to time-series data of a pressure received from a molding material, but may be other physical quantities, such as a position, speed, or torque of a configuration included in the injection molding machine 10. Furthermore, time-series data of a detection result by a detection device provided inside or outside the injection molding machine 10 may be used. The present embodiment is not limited to the mode of using one type of time-series data, and a plurality of types of time-series data may be used.

The abnormality detector 714 includes an inferrer 714A and performs abnormality detection processing in the injection molding machine 10 based on the waveform data acquired by the acquirer 713.

The inferrer 714A, for example, inputs waveform data indicating a result detected by the detection device (e.g., the load detector 360) in a time-series manner to the input layer of the trained model LM while the molded article is formed by the injection molding processor 712, and receives, from the output layer of the trained model LM, waveform data (an example of output data) inferred as time-series data of a result detected by the detection device in a time zone corresponding to the input waveform data. In the present embodiment, a pressure value included in the waveform data that is output from the trained model LM is referred to as a “inferred pressure value”.

In the case where the waveform data acquired by the acquirer 713 is larger than the data size of the fixed length of the input layer of the trained model LM, the inferrer 714A deletes data (actual pressure values detected after 10 seconds (an example of a predetermined cycle time)) from the waveform data so as to have a data size of the fixed length, and inputs the waveform data having a data size of the same fixed length as that of the input layer to the trained model LM. The inferrer 714A according to the present embodiment can reduce a calculation load as compared with the case of resampling by setting the waveform data to a fixed length in the above-described processing.

The abnormality detector 714 is provided with a preprocessor (not illustrated) for performing standardization or normalization on the waveform data before inference is performed by the inferrer 714A. The preprocessor may perform one or more of missing value processing and resampling in addition to standardization or normalization. For example, the preprocessor according to the present embodiment divides the actual pressure value included in the waveform data acquired by the acquirer 713 by a predetermined pressure value, and performs preprocessing so that the actual pressure value falls within a range of 1.0. In the present embodiment, since the estimation accuracy by the trained model LM is improved by performing the preprocessing, it is possible to improve accuracy in abnormality detection.

Then, the abnormality detector 714 performs control for detecting the abnormality based on the difference between the waveform data that is input to the trained model LM and the waveform data as the inference result that is output from the trained model LM.

The display controller 715 displays information on the display device 760. For example, the display controller 715 displays the result of the abnormality detection by the abnormality detector 714.

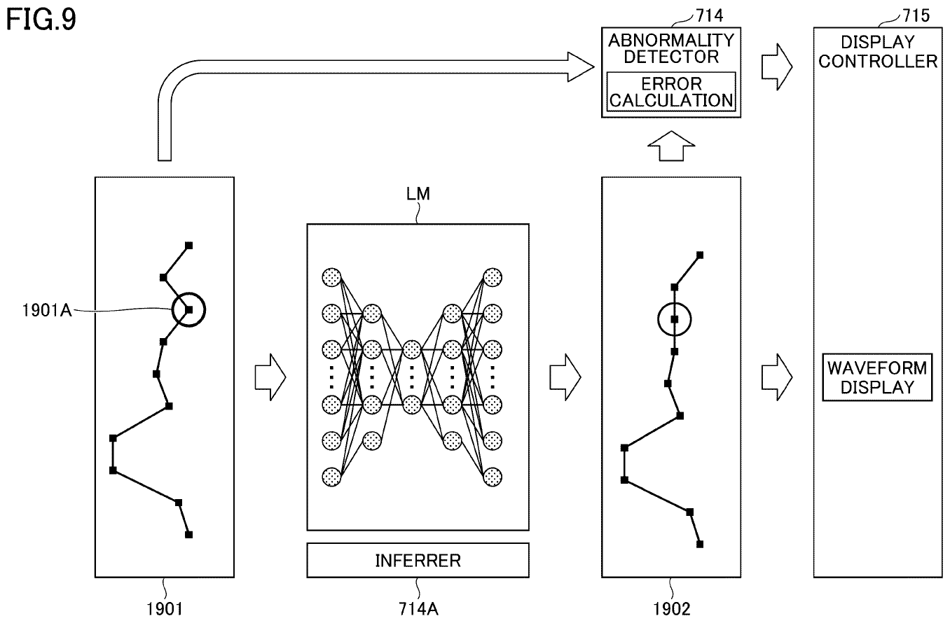

FIG. 9 is a diagram explaining a concept of processing performed by the abnormality detector 714 and the display controller 715 according to the present embodiment. As illustrated in FIG. 9, the inferrer 714A provided in the abnormality detector 714 inputs waveform data 1901 acquired by the acquirer 713 to the trained model LM having an encoder and a decoder, and receives the waveform data 1902 having the same data size (data length) as the input waveform data from the trained model LM.

The inferrer 714A uses the waveform data including the actual pressure value for 10 seconds (10 points) as the waveform data 1901 to be input to the trained model LM. Therefore, when the actual pressure value for 11 seconds (11 points) is detected as one shot, the inferrer 714A removes the actual pressure value for the last 1 second (1 point) and inputs the waveform data of the actual pressure value for 10 points to the trained model LM.

The waveform data 1901 illustrated in FIG. 9 is an example in which an abnormality occurs in the actual pressure value 1901A. Therefore, the actual pressure value 1901A is corrected in the waveform data 1902 that is output from the trained model LM.

The abnormality detector 714 calculates a value indicating the degree of abnormality between the input waveform data 1901 and the output waveform data 1902 (hereinafter also referred to as “abnormal pressure value”). As a method of calculating a value indicating the degree of abnormality, well-known methods, such as root mean square error (RMSE), mean square error (MSE), mean absolute error (MAE), and cosine similarity, may be used, and in the present embodiment, MSE (mean square error) is used.

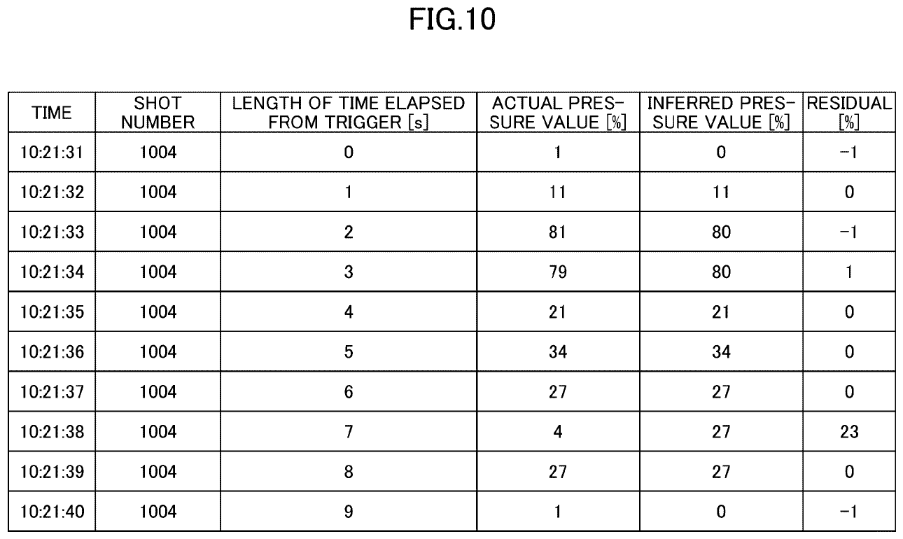

FIG. 10 is an explanatory diagram illustrating a residual calculated by the abnormality detector 714 according to the present embodiment. In the example illustrated in FIG. 10, a time, a shot number, a length of time elapsed from a trigger, an actual pressure value, an inferred pressure value, and a residual are illustrated. In the example illustrated in FIG. 10, it is assumed that the actual pressure values and inferred pressure values are normalized to 0 to 100% by preprocessing.

In the example illustrated in FIG. 10, the actual pressure value included in the input waveform data 1901 and the inferred pressure value included in the output waveform data 1902 are illustrated for each length of time elapsed from the trigger for the shot number “1004”. Furthermore, the residual obtained by subtracting the actual pressure value from the inferred pressure value is illustrated.

In the example illustrated in FIG. 10, the residual is “23” at the length of time “7” elapsed from the trigger for the shot number “1004”. The elapsed time “7” from the trigger is the time at which the actual pressure value 1901A of the waveform data 1901 illustrated in FIG. 9 occurs.

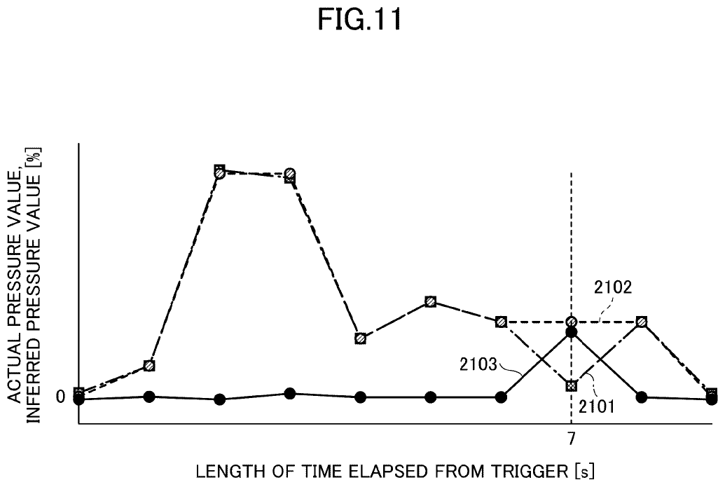

FIG. 11 is a graph illustrating an actual pressure value, an inferred pressure value, and a residual at the shot number “1004” by the injection molding machine 10 according to the present embodiment. In the example illustrated in FIG. 11, a line 2101 shows the actual pressure value, a line 2102 shows the inferred pressure value, and a line 2103 shows the residual.

As illustrated in FIG. 11, a deviation occurs between the actual pressure value and the inferred pressure value at the elapsed time “7” from the trigger, and the residual becomes large.

As described above, the inference by the inferrer 714A produces an inference result that reproduces the input waveform data as much as possible when the molding is normally performed.

On the other hand, in the examples illustrated in FIGS. 10 and 11, the residual between the inferred pressure value and the actual pressure value becomes large at the elapsed time “7” from the trigger of the shot number “1004”.

In the case of the trained model LM functioning as an autoencoder as in the present embodiment, there is a tendency that waveform data having abnormal features deviating from the trend of the data used for learning cannot be correctly inferred.

Therefore, the abnormality detector 714 according to the present embodiment detects the presence of an abnormality for each shot by evaluating an error between the input waveform data and the output waveform data by utilizing the property that waveform data having abnormal features cannot be correctly inferred.

For example, the abnormality detector 714 detects the presence of abnormality by using MSE (mean square error). In the present embodiment, a degree of pressure abnormality is used as an index for determining the presence of an abnormality. In the case of a residual [−1, 0, −1, 1, 0, 0, 0, 23, 0, −1] (unit: “%”) of the shot number “1004”, the abnormality detector 714 calculates a degree of pressure abnormality from the following Expression 1. In the example illustrated by the Expression 1, “0.533(%)” is calculated as the degree of pressure abnormality.

{(−0.01)²+(0)²+(−0.01)²+(0.01)²+(0)²+(0)²+(0)²+(0.23)²+(0)²+(−0.01)²}/10=0.00533 [Expression 1]

For example, the abnormality detector 714 can determine the presence of an abnormality based on whether the calculated degree of pressure abnormality meets or exceeds a threshold value. The threshold value may be determined depending on the embodiment.

The degree of pressure abnormality calculated by the MSE (mean square error) or the like reflects the degree of abnormality of the waveform data. In the present embodiment, the calculated degree of pressure abnormality may be monitored by a method similar to a conventional method.

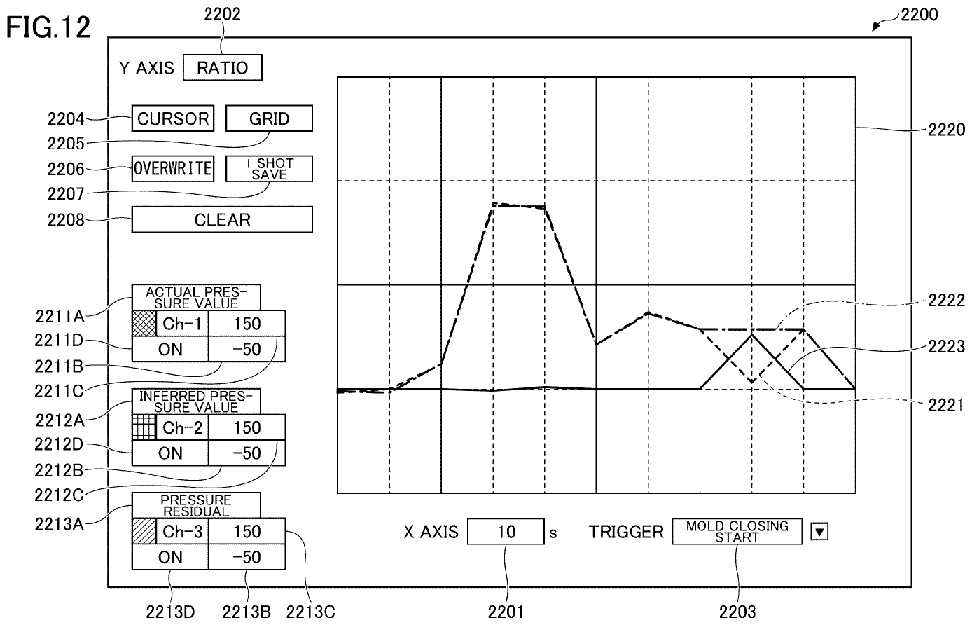

The display controller 715 displays the result calculated by the abnormality detector 714. FIG. 12 illustrates an example of a screen displayed on the display device 760 by the display controller 715 according to the embodiment.

The screen example illustrated in FIG. 12 is a screen for displaying information for each shot as a graph. For example, in a screen 2200, the setting “10 s (seconds)” is set in the X-axis input field 2201, the “ratio” is set in the Y-axis input field 2202, and “mold closing start” is set as a trigger 2203 for starting display. According to these settings, a graph is displayed in the display area 2220.

In the screen 2200 illustrated in FIG. 12, when the pressing of the “CURSOR” button 2204 or the “GRID” button 2205 is received, the display controller 715 switches the display mode of the graph displayed in the display area 2220.

In the screen 2200 illustrated in FIG. 12, when the pressing of the “OVERWRITE” button 2206 is received, the display controller 715 overwrites and displays a graph for each shot in the display area 2220.

In the screen 2200 illustrated in FIG. 12, when the pressing of the “1 SHOT SAVE” button 2207 is received, the control device 700 performs control for saving the information of the current shot displayed in the display area 2220. When the pressing of the “CLEAR” button 2208 is accepted, the control device 700 initializes the display of the display area 2220.

In the screen 2200 illustrated in FIG. 12, the information that is set in “CH-1” to “CH-3” is displayed in the display area 2220.

“ACTUAL PRESSURE VALUE” is set in the setting field 2211A of “CH-1”. “−50” is set in the lower limit value setting field 2211B of “CH-1,” and “150” is set in the upper limit value setting field 2211C. Since “ON” is set in the setting field 2211D, the information that is set in “CH-1” is displayed in the display area 2220.

Thus, the display controller 715 displays waveform data for one shot of the actual pressure value received from the molding material detected by the load detector 360 as a line 2221 in the display area 2220. The upper limit value of the Y-axis in the display area 2220 is “150”, and the lower limit value is “−50”. Since the values are displayed in a ratio, the unit is [%].

An “inferred pressure value” is set in the setting column 2212A of “CH-2”. “−50” is set in the lower limit value setting field 2212B of “CH-2,” and “150” is set in the upper limit value setting field 2212C. Since “ON” is set in the setting field 2212D, the information that is set in “CH-2” is displayed in the display area 2220.

As a result, the display controller 715 displays the waveform data indicating the inferred pressure value for one shot (10 seconds) that is output by the inferrer 714A as a line 2222 in the display area 2220. The upper limit value of the Y-axis in the display area 2220 is “150”, and the lower limit value is “−50”. Since the values are displayed in a ratio, the unit is [%].

An “PRESSURE RESIDUAL” is set in the setting column 2213A of “CH-3”. “−50” is set in the lower limit value setting field 2213B of “CH-3”, and “150” is set in the upper limit value setting field 2213C. Since “ON” is set in the setting field 2213D, the information that is set in “CH-3” is displayed in the display area 2220.

As a result, the display controller 715 displays the change in the residual obtained by subtracting the actual pressure value from the inferred pressure value as a line 2223 in the display area 2220. The upper limit value of the Y-axis in the display area 2220 is “150”, and the lower limit value is “−50”. Since the values are displayed in a ratio, the unit is [%].

Therefore, under the control of the display controller 715, the display device 760 causes a display panel (an example of a display) to display a difference (residual), in a graph format, between waveform data that is input to the trained model LM and waveform data received from the trained model LM as an inference result, by inputting the waveform data indicating, in time series, a result detected by a detection device provided in the injection molding machine 10 during one shot in which a molding article is molded by the injection molding machine 10.

By referring to the screen 2200 illustrated in FIG. 12, the user can recognize the presence of an abnormality based on whether the pressure residual is excited or not. Thus, in the example illustrated in FIG. 12, the user can recognize the presence of an abnormality by displaying at least one or more of the pressure inferred value or the pressure residual as a waveform. The display device 760 may use a method of displaying a threshold value for the pressure residual on the screen 2200 and detecting an abnormality depending on whether the pressure residual exceeds the threshold value.

Examples of screens displayed by the display controller 715 according to the present embodiment are not limited to the example illustrated in FIG. 12.

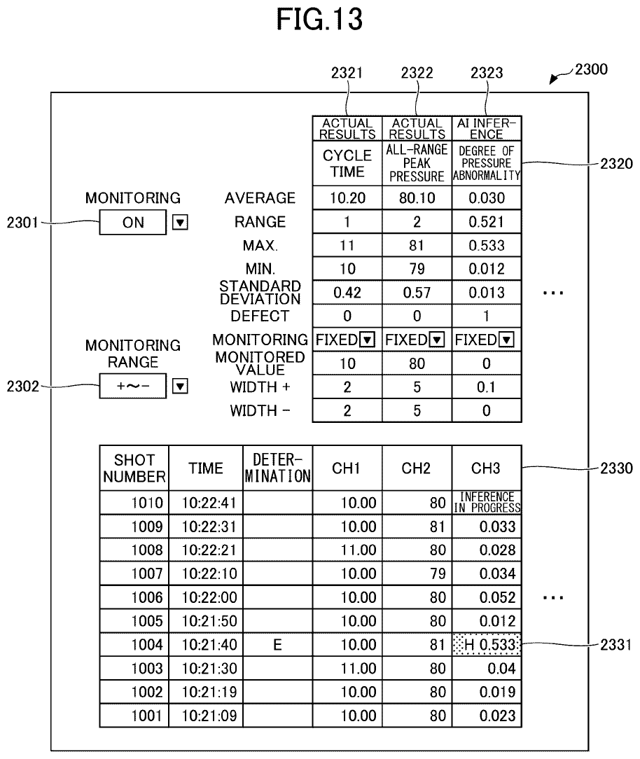

FIG. 13 illustrates a log information screen that is output by the display controller 715 according to the present embodiment.

In the log information screen 2300 illustrated in FIG. 13, a monitoring setting field 2301, a monitoring range setting field 2302, a statistics list 2320, and a result list 2330 are illustrated.

The statistics list 2320 shows statistical values (e.g., mean, range, maximum value, minimum value, standard deviation) for each of the setting fields 2321 through 2323. The content indicated in the setting fields 2321 through 2323 can be set by the user. In the present embodiment, the items illustrated in the setting fields 2321 through 2323 can be displayed and monitored. The monitoring in the present embodiment means the determination of whether a molded product is defective or not based on a predetermined criterion.

“Monitored value”, “width+”, and “width−” in the statistics list 2320 are information for determining whether a molded product in the setting field is defective or not.

When “monitoring” in the statistics list 2320 is indicated “fixed”, the control device 700 performs monitoring. When “monitoring” is “fixed”, the abnormality detector 714 of the control device 700 determines whether the measured actual value in the item indicated in the setting field satisfies the criterion indicated by “monitored value”, “width+”, and “width−”.

“Defect” in the statistics list 2320 indicates the number of molded articles that do not satisfy the criteria indicated by “monitored value”, “width+”, and “width−”.

The item “cycle time” in the setting field 2321, the item “overall peak pressure” in the setting field 2322, and the item “degree of pressure abnormality” in the setting field 2323 are items set for monitoring cycle, filling, and pressure abnormalities.

The item “degree of pressure abnormality” indicates a degree of pressure abnormality calculated by the abnormality detector 714.

The setting fields 2321 through 2323 can be changed to items that the user desires to monitor. Description of the changing method is omitted. The log information screen 2300 illustrated in FIG. 13 is merely an example, and the number of items in the statistics list 2320 is not limited to three, and for example, four or more items may be displayed.

The result list 2330 represents, for each shot, a list of result values measured by various detection devices or an inference result inferred by a machine learning model (e.g., trained model LM) in the items that are set in the setting fields 2321 through 2323. The items that are set in the setting fields 2321 through 2323 are set with “CH-1” through “CH-3”.

In the result list 2330, “shot number”, “time” at which injection molding is performed, and “determination” resulting from monitoring that is set by the statistics list 2320 are associated with each shot as information indicating the shot. In the result list 2330, “inference in progress” is displayed while inference is being performed by the machine learning model (e.g., trained model LM). After inference using the machine learning model (e.g., trained model LM) by the inferrer 714A is completed and a value to be displayed for the item is calculated, the display controller 715 updates the display so that the calculated value is displayed.

The monitoring setting field 2301 is a pull-down menu for accepting whether monitoring is performed or not in accordance with the items to be monitored on the statistics list 2320. When “ON” is selected in the monitoring setting field 2301, whether the product is defective or not is monitored for each shot, and the monitoring result is displayed in the “DETERMINATION” field. The monitoring setting field 2301 is switched to “OFF” or “ON” according to a selection by the user.

The monitoring range setting field 2302 is a pull-down menu for setting a monitoring range. When “+˜-” is selected in the monitoring range setting field 2302, the abnormality detector 714 determines whether the calculated value is included or not in the range indicated by “width+” and “width−” based on the “monitoring value” of the statistics list 2320. For example, when the “monitored value” is “0”, the “width+” is “0.1”, and the “width−” is “0”, the abnormality detector 714 determines that the calculated value is normal when it is within the range of the lower limit value “0” (“monitored value” minus “width−”) to the upper limit value “0.1” (“monitored value” plus “width+”), and determines that the calculated value is abnormal when it is outside the range of “0” to “0.1”.

For example, in the row 2331, since the “degree of pressure abnormality” is “0.533”, it falls outside of the monitoring range of “0” to “0.1”. Therefore, the determination “E” (Error) is displayed.

Therefore, under the control of the display controller 715, the display device 760 causes a display panel (an example of a display) to display a difference, as “abnormal pressure value”, between waveform data that is input to the trained model LM and waveform data received from the trained model LM as an inference result, by inputting the waveform data indicating, in time series, a result detected by a detection device provided in the injection molding machine 10 during one shot in which a molding article is molded by the injection molding machine 10.

By referring to the “abnormal pressure value” for each shot on the log information screen 2300 illustrated in FIG. 13, the user can recognize the presence of an abnormality for each shot.

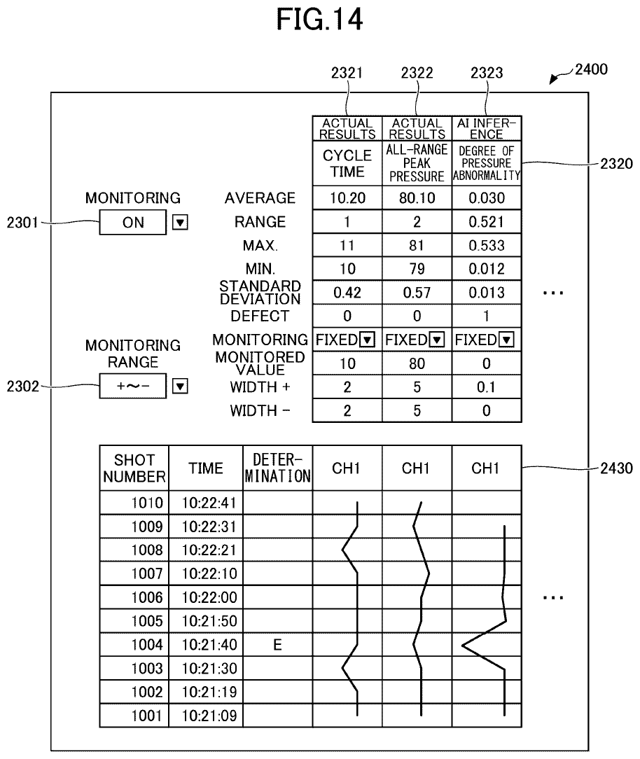

FIG. 14 illustrates another aspect of a log information screen that is output by the display controller 715 according to the present embodiment.

In the log information screen 2400 illustrated in FIG. 14, the monitoring setting field 2301, the monitoring range setting field 2302, the statistics list 2320, and the result list 2430 are illustrated. The log information screen 2400 illustrated in FIG. 14 differs from the log information screen 2300 illustrated in FIG. 13 in the display mode of the result list 2430. Other items are the same as those on the log information screen 2300 illustrated in FIG. 13, and description thereof is omitted.

The result list 2430 represents, for each shot, a graph of result values measured by various detection devices or an inference result inferred by a machine learning model (e.g., trained model LM) in the items that are set in the setting fields 2321 through 2323. The items that are set in the setting fields 2321 through 2323 are set with “CH-1” through “CH-3”, respectively. Since the result list 2430 displays changes in each value in “CH-1” through “CH-3” in a graph, this makes it easier for the user to recognize changes in each shot.

In the present embodiment, an example of detecting the presence of an abnormality by calculation using MSE (mean square error) for a difference between waveform data that is input to the trained model LM and waveform data that is output from the trained model LM has been described. However, the present embodiment is not limited to this method, and for example, the presence of an abnormality may be detected based on whether the above-described residual (for example, pressure residual) meets of exceeds a threshold value. The present embodiment shows an example of abnormality detection and is not limited to the above-described detection method. As a method for detecting an abnormality, any method may be used as long as it can evaluate a difference between waveform data that is input to the trained model LM and waveform data that is output from the trained model LM for each shot.

### Second Embodiment

In the above-described embodiment, an example has been described in which the control device 700 of the injection molding machine 10 detects an abnormality using the trained model LM as a management device for the injection molding machine 10. However, the above-described embodiment is not limited to a method in which the control device 700 of the injection molding machine 10 detects an abnormality using the trained model LM. In the second embodiment, an example in which a group management device 2500 for controlling the injection molding machine 10 detects an abnormality using the trained model LM will be described.

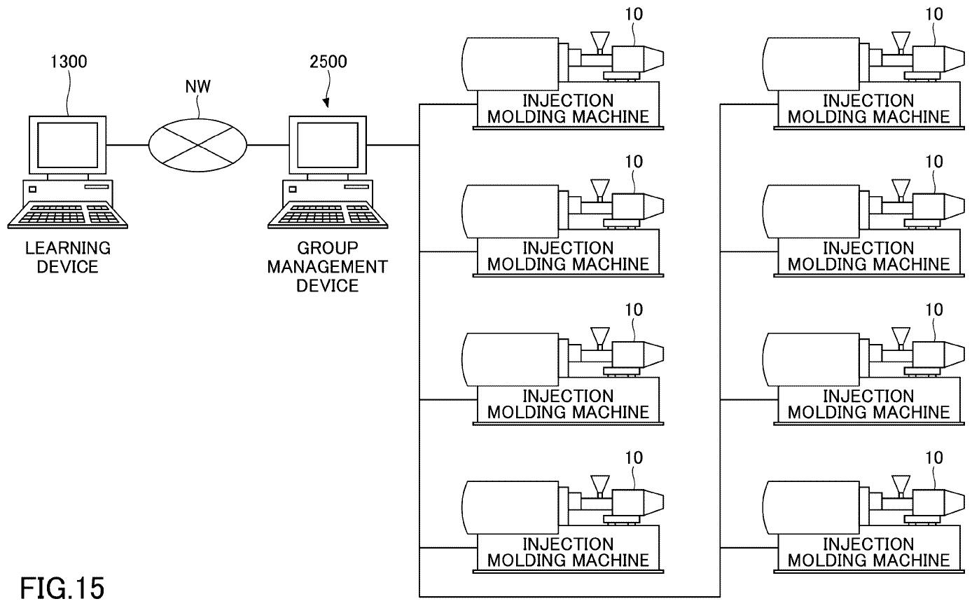

FIG. 15 illustrates configurations of the machine learning device 1300, a group management device 2500, and the injection molding machine 10 according to the present embodiment. As illustrated in FIG. 13, the group management device 2500 manages, for example, eight injection molding machines 10. The number of injection molding machines to be managed may be freely determined.

In the present embodiment, the abnormality detection using the trained model LM by the control device 700 illustrated in the foregoing embodiment is applied to the group management device 2500 having a group management function for a plurality of injection molding machines 10.

The machine learning device 1300 according to the present embodiment has the same configuration as that of the first embodiment. The machine learning device 1300 transmits information about the trained model LM to the group management device 2500 via a communication line NW.

The communication line NW is, for example, an Internet communication line. When communication is performed between the machine learning device 1300 and the group management device 2500, it is preferable to connect them by a VPN (virtual private network). By connecting them by a VPN, the security of communication can be improved.

The group management device (an example of a management device) 2500 is a device for managing a plurality of injection molding machines 10 from the viewpoint of productivity, and is connected to each injection molding machine 10, and receives molding conditions and results detected by various detection devices, as in the case of the control device 700 described in the foregoing embodiment, to assist management and planning of the production state.

The group management device 2500 may be implemented by a personal computer, for example. However, although the group management device 2500 does not normally have a control function of injection molding operation for each injection molding machine 10, it can be provided with such a control function by extending the function of a personal computer.

The group management device 2500 has a storage medium (not illustrated) like the control device 700, and the trained model LM is stored in the storage medium.

The group management device 2500 has a CPU (not illustrated) like the control device 700, and a communication controller 711, an acquirer 713, an abnormality detector 714, and a display controller 715 are realized by causing the CPU to execute a program stored in the storage medium, like the control device 700. The processing executed in each configuration is the same as in the above-described embodiments, and description thereof is omitted.

The group management device 2500 can be connected to the machine learning device 1300 via the communication line NW.

The group management device 2500 receives information about the trained model LM from the machine learning device 1300. The group management device 2500 updates the trained model LM based on the information received.

For example, the acquirer 713 of the group management device 2500 acquires waveform data transmitted from each of the injection molding machines 10. The abnormality detector 714 of the group management device 2500 determines the presence of an abnormality based on the acquired waveform data. The determination method is similar to that of the above-described embodiment, and the description thereof is omitted.

A display device (not illustrated) is connected to the group management device 2500. Under the control of the group management device 2500, the display device connected to the group management device 2500 causes a display panel (an example of a display) to display information indicating a difference between waveform data that is input to the trained model LM and waveform data received from the trained model IM as an inference result, by inputting the waveform data indicating, in time series, a result detected by a detection device provided in the injection molding machine 10 during one shot in which a molding article is molded by the injection molding machine 10. Thus, for example, the display device displays the screen illustrated in FIGS. 12 through 14.

### Advantageous Effects

In the above-described embodiments, an abnormality can be easily detected based on a difference between the waveform data indicating the result detected by the detection device in time series during one shot and the waveform data that is output from the trained model LM.

Since the monitoring in the foregoing embodiments does not use a detected value at a predetermined point of time or a statistical quantity such as a maximum or a minimum as in the conventional monitoring function, it is possible to easily monitor detection of abnormality without requiring the user to be familiar with the characteristics of detected values.

Using conventional methods, detecting abnormalities is challenging unless a threshold or similar criterion is established after recognizing a change when an abnormality occurs. In this embodiment, the change when an abnormality occurs can be easily recognized from a difference between the waveform data that is input to the trained model LM and the waveform data that is output from the trained model LM, so that the setting burden for detecting abnormalities can be reduced.

In order to detect abnormalities of a molded article, a method of inputting an image illustrating a molded article to the machine learning model can be considered. The detection of quality defects using such an image requires an addition of peripheral equipment, such as an image inspection device.

In contrast, in the above-described embodiments, since an abnormality can be detected from a result detected by the detection device incorporated in the injection molding machine 10, the detection of quality defects can be easily realized.

Furthermore, as a mode of inputting waveform data to the machine learning model, there is also a method of inputting image data representing a waveform. In this method, since image processing is performed, the calculation load becomes large.

In contrast, in the above-described embodiments, waveform data indicating a result detected by the detection device in time series, in other words, one-dimensional data, is input to the trained model LM. Thus, an amount of data that is input to the trained model LM can be suppressed. Therefore, in the above-described embodiments, the scale of the trained model LM can be reduced, and the processing load can be reduced.

Thus, the preferred embodiments of the present disclosure have been described. However, the present disclosure is not limited to the above-described embodiments. Various modifications, substitutions, and the like can be applied to the above-described embodiment without departing from the scope of the present disclosure. Each of the features described with reference to the above-described embodiments may be suitably combined as long as there is no technical conflict.

The embodiments disclosed above have the following aspects, for example.

### (Clause 1)

A control device for an injection molding machine, the control device including a controller configured to: acquire first time-series data indicating in time series a result detected by a detection device provided in the injection molding machine for each shot in which a molded article is molded by the injection molding machine; receive, from a trained model, inferred output data as time-series data of the result detected by the detection device in a time zone corresponding to the first time-series data, in a case where the first time-series data is input to the trained model in which machine learning is performed for inferring a time series of the result detected by the detection device for each shot in the injection molding machine; and perform control for detecting an abnormality based on a difference between the first time-series data and the output data.

### (Clause 2)

The control device for the injection molding machine according to Clause 1, wherein the trained model includes an input layer, one or more intermediate layers connected to the input layer, and an output layer connected to the one or more intermediate layers, and is formed as an encoder-decoder model.

### (Clause 3)

The control device for an injection molding machine according to Clause 2, wherein each of an input into the input layer and an output from the output layer of the machine learning model has a fixed data size.

### (Clause 4)

The control device for an injection molding machine according to Clause 3, wherein when the first time-series data that is input as a result detected by the detection device is larger than the fixed data size, the controller deletes data from the first time-series data so that the data size becomes the fixed data size, and inputs the first time-series data after the deletion to the trained model.

### (Clause 5)

A management device for an injection molding machine, the management device including a controller configured to: receive, from the injection molding machine, first time-series data indicating in time series a result detected by a detection device provided in the injection molding machine for each shot in which a molded article is molded by the injection molding machine; receive, from a trained model, output data inferred as time series data of the result detected by the detection device in a time zone corresponding to the first time-series data, in a case where the first time-series data is input to the trained model in which machine learning is performed for inferring a time series of the result detected by the detection device for each shot in the injection molding machine; and perform control for detecting an abnormality based on a difference between the first time-series data and the output data.

### (Clause 6)

A display device including a display configured to display information based on a difference between first time-series data and output data, the first time-series data being input to a trained model for each shot in which a molding article is molded by the injection molding machine, the output data being inferred by and received from the trained model, the trained model being trained to infer time-series data of a result detected by a detection device provided in the injection molding machine for each shot in a time zone corresponding to the input first time-series data.

### (Clause 7)

An injection molding machine including a detection device, and a controller configured to: acquire first time-series data indicating the result detected by the detection device in time series for each shot in which a molded article is molded by the injection molding machine; receive, from a trained model, output data inferred as time series data of the result detected by the detection device in a time zone corresponding to the first time-series data, in a case where the first time-series data is input to the trained model in which machine learning is performed for inferring a time series of the result detected by the detection device for each shot in the injection molding machine; and perform control for detecting an abnormality based on a difference between the first time-series data and the output data.

### (Clause 8)

An injection molding machine including a detection device, and a display configured to display information based on a difference between first time-series data and output data, the first time-series data being input to a trained model for each shot in which a molding article is molded by the injection molding machine, the output data being inferred by and received from the trained model, the trained model being trained to infer time-series data of result detected by a detection device for each shot in a time zone corresponding to the input first time-series data.

### (Clause 9)

A machine learning device for training a neural network, the machine learning device including a learning part for training a neural network using first time-series data in such a manner that the neural network outputs second time-series data similar to the first time-series data when the first time series data indicating, in time series, a result detected by a detection device provided in an injection molding machine is input during one shot in which a molded article is molded by the injection molding machine.

What is claimed is:

1. A control device for an injection molding machine, the control device comprising:
a controller configured to
acquire first time-series data indicating in time series a result detected by a detection device provided in the injection molding machine for each shot in which a molded article is molded by the injection molding machine;
receive, from a trained model, inferred output data as time-series data of the result detected by the detection device in a time zone corresponding to the first time-series data, in a case where the first time-series data is input to the trained model in which machine learning is performed for inferring a time series of the result detected by the detection device for each shot in the injection molding machine; and
perform control for detecting an abnormality based on a difference between the first time-series data and the output data.

2. The control device for the injection molding machine according to claim 1, wherein
the trained model includes an input layer, one or more intermediate layers connected to the input layer, and an output layer connected to the one or more intermediate layers, and is formed as an encoder-decoder model.

3. The control device for an injection molding machine according to claim 2, wherein
each of an input into the input layer and an output from the output layer of the machine learning model has a fixed data size.

4. The control device for an injection molding machine according to claim 3, wherein
when the first time-series data that is input as a result detected by the detection device is larger than the fixed data size, the controller deletes data from the first time-series data so that the data size becomes the fixed data size, and inputs the first time-series data after the deletion to the trained model.

5. A display device, comprising:
a display configured to display information based on a difference between first time-series data and output data, the first time-series data being input to a trained model for each shot in which a molding article is molded by the injection molding machine, the output data being inferred by and received from the trained model, the trained model being trained to infer time-series data of a result detected by a detection device provided in the injection molding machine for each shot in a time zone corresponding to the input first time-series data.

6. An injection molding machine, comprising:
a detection device; and
a controller configured to
acquire first time-series data indicating the result detected by the detection device in time series for each shot in which a molded article is molded by the injection molding machine;
receive, from a trained model, output data inferred as time series data of the result detected by the detection device in a time zone corresponding to the first time-series data, in a case where the first time-series data is input to the trained model in which machine learning is performed for inferring a time series of the result detected by the detection device for each shot in the injection molding machine; and
perform control for detecting an abnormality based on a difference between the first time-series data and the output data.

7. An injection molding machine, comprising:
a detection device; and
a display configured to display information based on a difference between first time-series data and output data, the first time-series data being input to a trained model for each shot in which a molding article is molded by the injection molding machine, the output data being inferred by and received from the trained model, the trained model being trained to infer time-series data of result detected by a detection device for each shot in a time zone corresponding to the input first time-series data.
